(19) United States
(12) Patent Application Publication
(10) Pub. No.: US 2025/0036432 A1
(43) Pub. Date: Jan. 30, 2025

(54) Methods for Representing Data Analysis and Systems for Same

(71) Applicant: The Regents of the University of California, Oakland, CA (US)

(72) Inventor: Michael Oldham, San Francisco, CA (US)

(21) Appl. No.: 18/658,264

(22) Filed: May 8, 2024

Related U.S. Application Data
(60) Provisional application No. 63/465,819, filed on May 11, 2023.

(51) Int. Cl. G06F 9/451; G06F 3/04817; G06F 16/25

(52) U.S. Cl. CPC G06F 9/451; G06F 3/04817; G06F 16/258

(57) ABSTRACT

Aspects of the present invention include methods of representing data analysis comprising: selecting input data comprising standardized data containers, based on a first input from a user, and arranging on a graphical interface graphical icons into a graphical workflow representing a data analysis, based on a second input from the user, wherein the workflow comprises a plurality of standardized data transformations and standardized data containers comprising intermediate and final results of the data analysis. Also provided are systems for performing the methods described herein as well as non-transitory computer readable storage mediums.

### CROSS-REFERENCE TO RELATED APPLICATION

Pursuant to 35 U.S.C. § 119 (e), this application claims priority to the filing date of United States Provisional Patent Application Ser. No. 63/465,819 filed May 11, 2023, the disclosure of which is herein incorporated by reference in its entirety.

### CROSS-REFERENCE TO RELATED APPLICATION

This invention was made with government support under R01 MH113896, and R01 MH123156 awarded by the National Institutes of Health. The government has certain rights in the invention.

### INTRODUCTION

Reproducibility is essential for scientific progress, but there are growing concerns in the life sciences that many published findings are not reproducible. See, e.g., Begley, C. G. & Ioannidis, J. P. A. Reproducibility in science: improving the standard for basic and preclinical research. Circ. Res. 116, 116-126 (2015); Freedman, L. P., Cockburn, I. M. & Simcoe, T. S. The economics of reproducibility in preclinical research. PLoS Biol. 13, e1002165 (2015); Macleod, M. & University of Edinburgh Research Strategy Group. Improving the reproducibility and integrity of research: what can different stakeholders contribute?BMC Res. Notes 15, 146 (2022); Frommlet, F. Improving reproducibility in animal research. Sci. Rep. 10, 19239 (2020); Munafó, M. R. et al. A manifesto for reproducible science. Nat. Hum. Behav. 1, 0021 (2017); Frye, S. V. et al. Tackling reproducibility in academic preclinical drug discovery. Nat. Rev. Drug Discov. 14, 733-734 (2015). The causes of the reproducibility crisis are complex and include technical, statistical, individual, and cultural factors. See, e.g., Munafó, M. R. et al. A manifesto for reproducible science. Nat. Hum. Behav. 1, 0021 (2017); Hunter, P. Technical bias and the reproducibility crisis: The problem of systemic errors resulting from artefacts of equipment, methods or dataset has been underappreciated. EMBO Rep. 22, e52327 (2021); Auer, S. et al. A community-led initiative for training in reproducible research. eLife 10, (2021); de Marco, A. et al. Quality control of protein reagents for the improvement of research data reproducibility. Nat. Commun. 12, 2795 (2021); Baker, M. Reproducibility crisis: Blame it on the antibodies. Nature 521, 274-276 (2015); Kapoor, S. & Narayanan, A. Leakage and the Reproducibility Crisis in ML-based Science. arXiv (2022) doi:10.48550/arxiv.2207.07048; Ioannidis, J. P. A. Why most published research findings are false. PLoS Med. 2, e124 (2005); Gerlovina, I., van der Laan, M. J. & Hubbard, A. Big data, small sample. Int. J. Biostat. 13, (2017); Bishop, D. Rein in the four horsemen of irreproducibility. Nature 568, 435 (2019); Martinez-Camblor, P., Pérez-Fernández, S. & Díaz-Coto, S. The role of the p-value in the multitesting problem. J. Appl. Stat. 47, 1529-1542 (2020); Miyakawa, T. No raw data, no science: another possible source of the reproducibility crisis. Mol. Brain 13, 24 (2020); Errington, T. M. et al. Investigating the replicability of preclinical cancer biology. eLife 10, (2021); Open Science Collaboration. Estimating the reproducibility of psychological science. Science 349, aac4716 (2015); Stupple, A., Singerman, D. & Celi, L. A. The reproducibility crisis in the age of digital medicine. npj Digital Med. 2, 2 (2019); Jubb, M. Peer review: The current landscape and future trends. Learn. Pub. 29, 13-21 (2016); Walker, R. & Rocha da Silva, P. Emerging trends in peer review-a survey. Front. Neurosci. 9, 169 (2015); Baldwin, M. In referees we trust? Phys. Today 70, 44-49 (2017); Lindner, M. D., Torralba, K. D. & Khan, N. A. Scientific productivity: An exploratory study of metrics and incentives. PLoS ONE 13, e0195321 (2018). Although many remedies have been proposed, there is one important category of research activities that should in principle be completely reproducible: computational research activities. Because analysis of large datasets underpins most modern scientific publications, ensuring that data and code are properly annotated and accessible for reanalysis is a prerequisite for reproducible research. However, the dominant form of scholarly communication (peer-reviewed scientific articles distributed as PDFs) does not facilitate reproducible data analysis, for many reasons. First, it is neither expected nor feasible for peer reviewers to guarantee the scientific accuracy of complex bioinformatic workflows. Second, data and/or code may be unavailable for reanalysis if this stipulation is not enforced by the publisher. Third, available data and code may not include all data and code used by the authors to derive their conclusions. Fourth, metadata may differ between journal articles and data repositories. Fifth, Methods sections may omit critical parameter choices, package versions, and other dependencies. And sixth, individuals may lack requisite computing resources to reproduce analyses.

Systematic efforts to reproduce research findings published in high-impact journals have yielded bleak success rates in disparate fields from pre-clinical cancer biology to psychology. See, e.g., Errington, T. M. et al. Investigating the replicability of preclinical cancer biology. eLife 10, (2021); Open Science Collaboration. Estimating the reproducibility of psychological science. Science 349, aac4716 (2015); Prinz, F., Schlange, T. & Asadullah, K. Believe it or not: how much can we rely on published data on potential drug targets? Nat. Rev. Drug Discov. 10, 712 (2011); Begley, C. G. & Ellis, L. M. Drug development: Raise standards for preclinical cancer research. Nature 483, 531-533 (2012); Errington, T. M., Denis, A., Perfito, N., Iorns, E. & Nosek, B. A. Challenges for assessing replicability in preclinical cancer biology. eLife 10, (2021). Concerns about reproducibility have also been raised in the fields of brain imaging, microscopy, single-cell analysis, and machine learning/artificial intelligence. See, e.g., Kelly, R. E. & Hoptman, M. J. Replicability in brain imaging. Brain Sci. 12, (2022); Veronese, M. et al. Reproducibility of findings in modern PET neuroimaging: insight from the NRM2018 grand challenge. J. Cereb. Blood Flow Metab. 41, 2778-2796 (2021); Botvinik-Nezer, R. et al. Variability in the analysis of a single neuroimaging dataset by many teams. Nature 582, 84-88 (2020); Nelson, G. et al. QUAREP-LiMi: A community-driven initiative to establish guidelines for quality assessment and reproducibility for instruments and images in light microscopy. J. Microsc. 284, 56-73 (2021); Skinnider, M. A., Squair, J. W. & Courtine, G. Enabling reproducible re-analysis of single-cell data. Genome Biol. 22, 215 (2021); Gibson, G. Perspectives on rigor and reproducibility in single cell genomics. PLoS Genet. 18, e1010210 (2022); Hutson, M. Artificial intelligence faces reproducibility crisis. Science 359, 725-726 (2018); Gibney, E. Could machine learning fuel a reproducibility crisis in science? Nature 608, 250-251 (2022). Furthermore, in a recent survey of 1,576 scientists by Nature35, more than 70% of respondents reported trying and failing to reproduce another scientist's experiments, and 90% agreed the reproducibility crisis is real. Baker, M. 1,500 scientists lift the lid on reproducibility. Nature 533, 452-454 (2016). This reality poses an existential threat to scientific research: If it is not feasible to reproduce or even attempt to reproduce most published findings, what is the point? By perpetuating irreproducible (i.e., wildly inefficient) research practices, scientists risk alienating those who fund their work, which in the United States is largely the taxpaying public. As such, there is an urgent need to reimagine ways to improve scientific communication that can sidestep the limitations of conventional peer review and scientific publishers, most of whom are not incentivized to solve this problem, since reproducibility is not essential for their business model.

### SUMMARY

Thus, there is a need for improved and useful methods and systems for improving reproducibility in computational research activities. This invention provides such new and useful methods and systems, addressing the limitations mentioned above. The inventor has recognized that computational research activities represent a special class of scientific research for which the reproducibility problem can be solved entirely through technology. Embodiments of the present invention enable visual, intuitive, and interactive representations of analytical workflows, while simultaneously simplifying data/code discovery, accelerating data analysis, building community, and guaranteeing reproducibility. To accomplish this, the invention leverages standardized constructs or elements to represent data and operations performed on data that can be arranged and configured using a graphical user interface to form graphical workflows. Embodiments of the present invention are configured such that once the graphical workflow represents the desired data analysis, the graphical workflow then performs the data analysis associated with the workflow. Such workflows can be shared and authenticated across different research groups utilizing different computing environments in different geographic locations.

Methods and systems for representing data analysis are provided. Aspects of the present invention include methods of representing data analysis comprising: selecting input data comprising standardized data containers, based on a first input from a user, and arranging on a graphical interface graphical icons into a graphical workflow representing a data analysis, based on a second input from the user, wherein the workflow comprises a plurality of standardized data transformations and standardized data containers comprising intermediate and final results of the data analysis. Aspects of the present invention further include various methods of interacting with a workflow as well as using a workflow to perform data analysis. Also provided are systems for performing the methods described herein as well as non-transitory computer readable storage media.

The methods and systems find use in a variety of different applications, e.g., in connection with analyzing empirical data in a manner that promotes reproducibility in arriving at scientific results or conclusions. In some cases, the methods and systems find use in practicing bioinformatics or utilizing bioinformatic processes. Embodiments of the methods, systems and non-transitory computer readable media described herein provide advantages, in part, because in some cases they enable utilizing standardized elements to represent a data analysis in the context of graphical workflows that are accessible even to users without computer programing abilities or similar technical knowledge and that are configured to facilitate collaboration, maintain data integrity, comprise searchable elements and promote enabling reproducible results in discovering and publishing scientific findings.

By assigning unique and persistent identifiers, e.g., DOIs, and standardizing metadata, embodiments of the present invention improve the findability, accessibility, interoperability, and reusability of research datasets, code, and analysis products. Integration with advanced search capabilities of embodiments of the present invention will dramatically simplify data and code discovery, while integration with cloud-based resources, such as, for example, AWS, will substantially accelerate data analysis. These benefits will make it far easier for investigators to identify gold-standard human “-omics” datasets and best analytical practices, providing a substantive new resource for investigators. Finally, the permanence, share-ability, interactivity, and guaranteed reproducibility of workflows of embodiments of the present invention will lead to new didactic methods that leverage workflow narrative structures to convey research motivations, methods, results, and interpretations more accessibly and quickly than existing practices, such as, for example, journal articles.

### BRIEF DESCRIPTION OF THE FIGURES

The invention may be best understood from the following detailed description when read in conjunction with the accompanying drawings. Included in the drawings are the following figures:

FIG. 1 depicts various aspects of data analysis capable of being performed by embodiments of the present invention.

FIG. 2 depicts a flow diagram for representing a data analysis according to embodiments of the present invention.

FIGS. 3A-B depict exemplary workflows according to embodiments of the present invention.

FIG. 4 depicts an excerpt of an exemplary workflow according to an embodiment of the present invention.

FIG. 5 depicts an exemplary container according to an embodiment of the present invention.

FIG. 6 depicts an exemplary container according to an embodiment of the present invention.

FIG. 7 depicts an exemplary container according to an embodiment of the present invention.

FIG. 8 depicts exemplary contents of a container according to an embodiment of the present invention.

FIG. 9 depicts an excerpt of an exemplary workflow according to an embodiment of the present invention.

FIG. 10 depicts exemplary standardized file types associated with a container or transformation according to an embodiment of the present invention.

FIGS. 11A-B depicts standardized attributes associated with a container or transformation according to an embodiment of the present invention as well as a technique involving an automated question-answer session according to an embodiment of the present invention for identifying and populating attributes of a container.

FIG. 12 depicts an excerpt of an exemplary workflow according to an embodiment of the present invention.

FIG. 13 depicts an excerpt of an exemplary workflow according to an embodiment of the present invention.

FIG. 14 depicts example search queries for use in embodiments of the present invention.

FIG. 15 depicts a flow diagram illustrating one embodiment of a method of the present invention.

FIG. 16 depicts various example tasks related to generating and utilizing workflows of embodiments of the present invention.

FIG. 17 depicts an exemplary data validation process for a workflow according to an embodiment of the present invention.

FIG. 18 depicts a general architecture of an example computing device according to certain embodiments.

### DETAILED DESCRIPTION

Aspects of the present invention include methods of representing data analysis comprising: selecting input data comprising standardized data containers, based on a first input from a user, and arranging on a graphical interface graphical icons into a graphical workflow representing a data analysis, based on a second input from the user, wherein the workflow comprises a plurality of standardized data transformations and standardized data containers comprising intermediate and final results of the data analysis. Also provided are systems for performing the methods described herein as well as non-transitory computer readable storage mediums.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise.

It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the system and method may be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

As summarized above, the present disclosure provides methods and systems for representing data analysis. By “data analysis,” it is meant any potential analytical process, procedure, algorithm, mathematical function, statistic or other data manipulation capable of being performed on data. Data analysis may be utilized in order to, for example, understand the data, study the data, utilize the data, such as utilize the data in connection with testing a hypothesis, or transform the data. Data analyses may comprise constituent steps of performing one or more operations or transformations on one or more input data elements thereby generating one or more output data elements. By “representing data analysis,” it is meant depicting constituent steps of a data analysis in a graphical format. In some cases, data analyses are represented in formats that obviate the need to directly write computer programming source code representing the data analyses in order to make such data analyses accessible to users not familiar with writing computer programming source code. Any convenient graphical format may be applied and such may vary. In embodiments, data analyses are represented in a standardized format, in which, e.g., related aspects of the data analysis are depicted in consistent ways. For example, data transformations may be depicted using similar icons. Further, in embodiments, representing data analyses in a standardized form comprises utilizing graphical representations—e.g., icons—in a graphical interface that are configured to interact with the user in a consistent manner. For example, standardized graphical representations of aspects of a data analysis may each respond by performing the same function when a user separately double clicks on each representation, such as, for example, opening a folder icon showing constituent files associated with each graphical representation or displaying aspects of experimental data associated with such graphical representations.

In embodiments, graphical representations of data analyses are referred to as workflows. Workflows are comprised of transformations, which, e.g., perform an operation or a transformation or a mathematical function or other manipulation using input data, and containers, which represent inputs to and output results of transformations, e.g., by housing data, such as data sets or raw data, such as data collected using laboratory protocols (e.g., data collected in a wet lab) or statistics generated by applying a transformation to a data set or processed or configured versions of data, such as images, graphs, plots, charts or the like, or reference data, such as reference genome data. Without limitation, workflows may be analogized to grammatical sentences with transformations as verbs and containers as nouns forming subjects and objects of verbs.

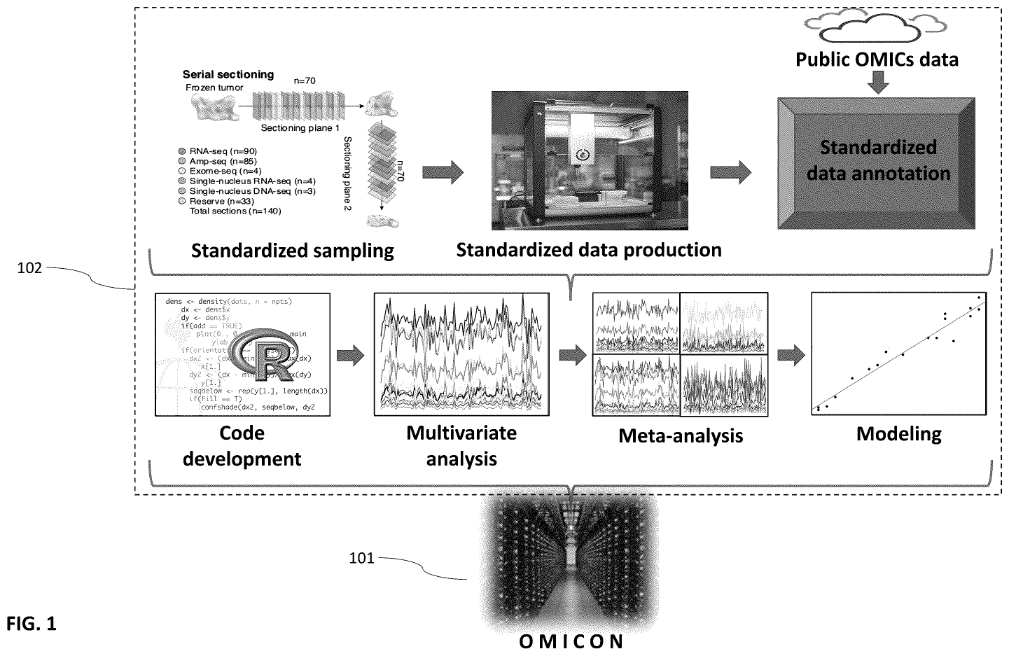

In embodiments, workflows may represent bioinformatic analysis, that is, bioinformatic operations performed on biologic data sets. However, workflows need not be so limited and may represent any potential data analysis not limited to biological or bioinformatic analyses. FIG. 1 presents a representation of various aspects of data analysis capable of being performed by embodiments of the present invention. That is, element 101 representing an embodiment of a computer-based system programmed to perform methods according to the present disclosure (embodiments of the present invention are, in some instances, be referred to as Omicon) is configured to be capable of representing each of the depicted analytical operations 102 including standardized data sampling, production, annotation, including standardized data annotation based at least in part on publicly available data, code development (i.e., computer code directed to performing constituent steps of a data analysis), multivariate analysis, meta-analysis and modeling.

### Methods for Representing Data Analysis

Aspects of the present disclosure include methods for representing data analyses, including graphical representations of workflows corresponding to data analyses, using standardized representations of containers and transformations, according to embodiments of the present invention. In particular, the present disclosure includes methods of representing data analysis comprising: selecting input data comprising standardized data containers, based on a first input from a user, and arranging on a graphical interface graphical icons into a graphical workflow representing a data analysis, based on a second input from the user, wherein the workflow comprises a plurality of standardized data transformations and standardized data containers comprising intermediate and final results of the data analysis.

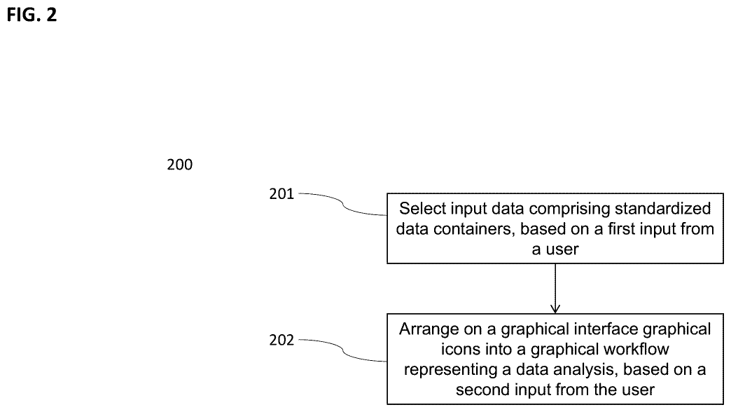

FIG. 2 illustrates a flow diagram 200 for representing a data analysis, such as a bioinformatic analysis, according to embodiments of the present invention. Flow diagram 200 starts at step 201. At step 201, a user (i.e., a user of a computer-implemented embodiment of a method of the present invention) selects input data for a workflow representing a data analysis, as described above. Such input data is represented by a standardized data container, as described further herein. The input data selected by the user may comprise, for example, one or more input data sets corresponding to results from one or more laboratory protocols (i.e., data collected via a wet lab protocol) or one or more data sets generated as a result of applying a separate, preliminary data analysis. For example, an input data set may be a tabulated list of analytes of interest and associated values indicating a degree to which such an analyte is detected in a sample. Alternatively, an input data set may be an image file that is a representation of certain experimental results, for example. The one or more standardized containers are associated with the selected input data. That is, the one or more standardized containers may comprise, or may otherwise be linked to, one or more files that comprise the selected input data. The one or more standardized data containers may be configured to be interacted with by a user via a graphical interface displaying a graphical representation of the workflow. The user may interact with the one or more standardized containers to access descriptive information about data associated with the container, such as details about how such data were collected. In some cases, the user interacts with such standardized containers in connection with selecting the desired input data at step 201. Once input data comprising standardized data containers are selected step 201, the process moves to step 202.

At step 201, graphical icons are arranged into a graphical workflow representing the data analysis via a graphical interface. In embodiments, such graphical icons are associated with data containers, such as the standardized data containers of step 201, as well as standardized representations of data transformations, as described above. Graphical icons corresponding to containers and transformation can be arranged (i.e., ordered) by a user interacting with the graphical interface in the form of a graph or directed graph or network or flowchart (i.e., a workflow) in a manner that corresponds to the analytical steps of the data analysis. That is, upon completion of step 202, containers and transformations are arranged into a workflow that provides a graphical representation of a data analysis. In general, workflows comprise at least one container corresponding to input data (i.e., initial data subject to the data analysis represented by the workflow), at least one transformation configured to take as input the input data container as well as at least one output data container corresponding to output data (i.e., the final data produced by applying the data analysis represented by the workflow). After completion of step 202, i.e., such that the graphical icons representing containers and transformations of the workflow are arranged such that they correspond to the constituent steps of the data analysis to be represented, the process ends at step 202.

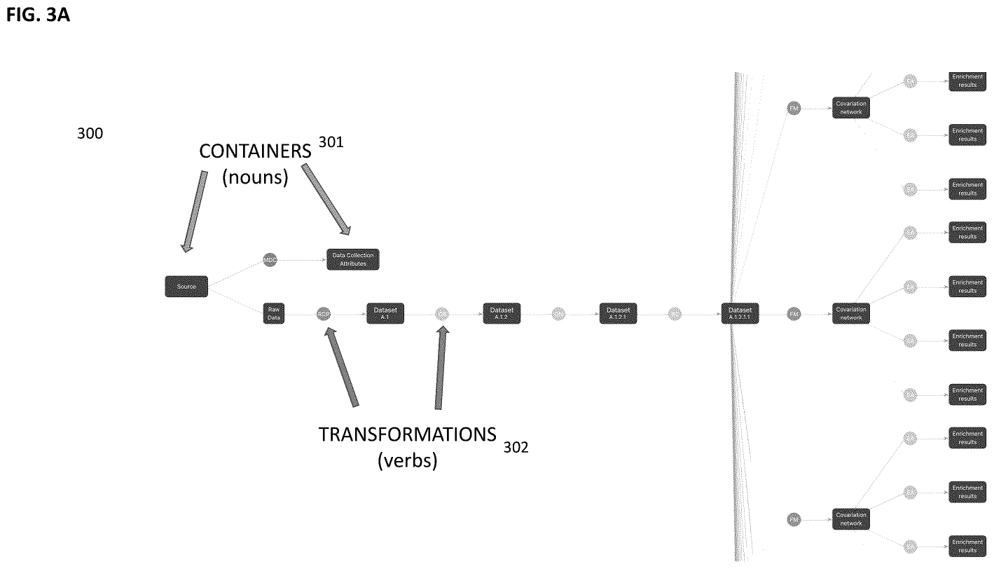

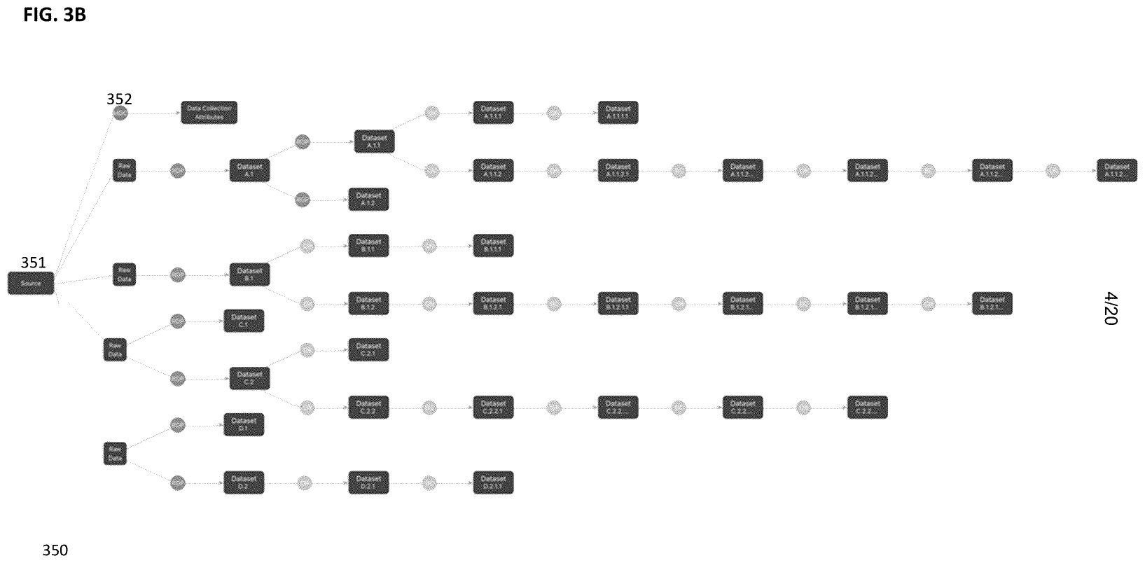

FIG. 3A presents an exemplary workflow according to an embodiment of the present invention. Workflow 300 is an excerpt of a graphical representation of an exemplary data analysis. Workflow 300 is a graphical workflow comprising a plurality of graphical icons representing containers 301, which are associated with data, such as input data or source data or intermediate or final results of the data analysis, as well as transformations 302, which represent analytical functions or operations performed on one or more input containers, resulting in outputting results into one or more output containers. Workflow 300 is a directed graph with containers 301 and transformations 302 as nodes connected by directed edges between. The data analysis depicted in exemplary workflow 300 proceeds from left to right with containers 301 on the far left representing initial input data and containers 302 on the far right representing final output data of workflow 300. Each transformation of transformations 302 are associated with one or more input container of containers 301 located immediately to the left of each transformation. Each transformation of transformations 302 are associated with one or more output container of containers 301 located immediately to the right of each transformation. As described herein, for illustration only and without limitation, workflow 300 may be analogous to a grammatical sentence with containers 301 as nouns acting as subjects and objects of the sentence and transformations 302 acting as verbs of the sentence, which is read from left to right. Workflow 300 represents a data analysis directed to preprocessing and gene coexpression analysis of human glioblastoma transcriptomes from IvyGAP (https://glioblastoma.alleninstitute.org/static/home). Workflow 300 was generated using an embodiment of the present invention that comprises pilot data from approximately 7,000 human malignant gliomas and further comprises a data model, a metadata standardization strategy, an advanced search engine, an interactive workflow visualization tool, and an intuitive and social user interface to enable discovery of and communication around data, code, and analysis products.

FIG. 3B presents another exemplary workflow according to an embodiment of the present invention. Workflow 350 is an excerpt of a graphical representation of an exemplary data analysis. Workflow 350 is a graphical workflow comprising a plurality of graphical icons representing containers 351 (rectangles), which are associated with data, such as input data or source data or intermediate or final results of the data analysis, as well as transformations 352 (circles), which represent analytical functions or operations performed on one or more input containers, resulting in outputting results into one or more output containers. Workflow 350 illustrates the preprocessing of four gene expression datasets derived from 1,339 glioblastoma samples from The Cancer Genome Atlas.

### Containers:

Embodiments of methods according to the present invention further comprise: selecting one or more containers, based on input from the user, and arranging one or more graphical icons representing the one or more containers in the graphical workflow representing the data analysis. In embodiments, the containers are associated with one or more files. In other embodiments, the containers comprise one or more files. That is, the containers may comprise data, including metadata, as described below, that is stored in the form of one or more files. Without limitation, in such cases, the container may be analogized to a computer file folder, i.e., a directory that comprises similar or related data files. In some embodiments, the containers are associated with standardized file types. In other embodiments, the containers comprise standardized file types. In some cases, the containers comprise standardized data. In embodiments, by standardized files and standardized data, it is meant files in which one or more aspects of data stored in the files is organized in a standardized format to make it accessible in a predictable manner. Standardized file types may be used in connection with any data type, such as genomic data, epigenomic data, results of performing gas or liquid chromatography or mass spectrometry on a sample, or results of applying flow cytometric analysis to a sample, for example. In some cases, data of interest may comprise information regarding one or more of: DNA (e.g., whole genomes, exons, amplicons, SNPs) or RNA (e.g., total, mRNA, lncRNA, miRNA, ribosomal) or proteins.

In embodiments, a container is a folder containing one or more well-described file types, along with its attributes. In some embodiments, containers are inputs to and outputs of transformations and pipelines (as described below). In other embodiments, metacontainers are containers that contain other containers.

As described above, containers may comprise any information used in connection with a data analysis, such as a bioinformatic analysis. In embodiments, containers comprise input data for the workflow, output data of the workflow or intermediate results of the workflow. In embodiments, containers comprise input data for a transformation or output data for a transformation, i.e., input to a transformation or output of applying a transformation. In some embodiments, containers comprise reference information. By reference information, it is meant information or data that is, for example, distinct from experimental data such that it is available to make comparisons against experimental data. In some cases, containers may comprise reference data comprising a reference genome. In other cases, containers comprise an image or a graph or a plot or other visual presentation of certain data. Such containers may be of use in connection with applying a transformation configured to present analytical results or to process certain input by extracting data from an image or a graph or a plot or other visual presentation of certain data.

In embodiments, the transformations and containers are modular. That is, transformations and containers are standardized entities or instances of data and operations on data and can be fit together in different configurations as desired to represent the workflow. Without limitation, containers and transformations may be analogous to different computer code modules capable of being fit together in different combinations and different orders.

### Container Attributes:

In embodiments, containers comprise standardized metadata. In some cases, such standardized metadata are container attributes. Embodiments of the present invention may utilize container attributes in connection with providing modular, searchable, and more informative or user-friendly representations of data analyses, as described below. In some cases, the container metadata or the container attributes comprise annotations, such as annotations regarding data associated with the container. Any convenient annotations may be provided, such as, for example, information about when or where or how data associated with the container was collected or is being used or may be used. Annotations may take the form of structured fields, such as flags or prepopulated data fields, or may take the form of unstructured fields in which a narrative description is entered. Such narrative descriptions may take the form of natural language descriptions or mathematical formulae or pseudo code or the any other form of description relevant to data or information associated with a container. The standardization represented by container attributes is utilized by some embodiments of the present invention to comprise a search engine capable of performing complex queries to identify data, such as biological data with desired attributes.

Embodiments of the present invention further comprise annotating a container or attribute. Some embodiments of the present invention further comprise populating container attributes. In some cases, annotating a container comprises populating container attributes based on input received from the user. In other cases, annotating a container comprises processing input data related to data associated with a container. In such cases, input data related to data associated with a container may comprise any relevant information associated with a container that a user desires to record in the workflow. In some cases, input data related to data associated with a container comprises one or more of a written description, a publication or a record of responses to questions related to the data associated with the container.

In embodiments, annotating a container comprises: training a machine learning model to annotate a container using descriptions of existing containers and corresponding attributes of the existing containers as training data; applying the machine learning model to a description of the data associated with the container; and annotating the transformation based on results of applying the machine learning model. In other embodiments, annotating a container comprises applying a machine learning model, trained to identify container attributes based on a description, to a description of the data associated with the container, and annotating the container based on results of applying the machine learning model. In some embodiments, a machine learning model may comprise one or more of: a statistical model, a linear model, a computational model, a tree-based model, a convolutional neural network, an artificial neural network or a deep learning network, as such models and techniques for training and applying them are known in the art. In embodiments, a machine learning model may comprise linear and tree-based baseline models, autoML-based boosted and ensemble models, and deep learning models. In certain cases, training the machine learning model comprises one or more of: an unsupervised learning technique, a semi-supervised learning technique or a supervised learning technique, as such techniques are known in the art.

In embodiments, training a machine learning model to annotate a container comprises utilizing one or more of stratified sampling, held out test set, cross validation, hyper parameter tuning or random grid search. In some cases, evaluating the accuracy of annotating a container by the model comprises using any available technique for assessing the accuracy of the model, such as, for example, using one or more of held out test sets and cross validation evaluations. In other cases, further training the machine learning model using descriptions of existing containers and corresponding attributes of the existing containers comprises training the machine learning model using the plurality of descriptions of existing containers and corresponding attributes of the existing containers in their entirety.

Embodiments of the present invention further comprise defining types of containers or transformations or attributes, based on input received from the user. That is, a user may, for example, interact with a graphical user interface, in order to create a new type of container or transformation or attribute (i.e., an attribute of a container or transformation) such that the newly defined container or transformation or attribute thereof may be utilized in the present workflow. Other embodiments of the present invention further comprise creating new containers or transformations or attributes by importing one or more data set or analytical operation, based on input received from the user. That is, such containers or transformations or attributes, having already been created in, for example, a different workflow or other separate context, may be imported (e.g., by the user interacting with a graphical user interface) such that they are available to be used in the present workflow.

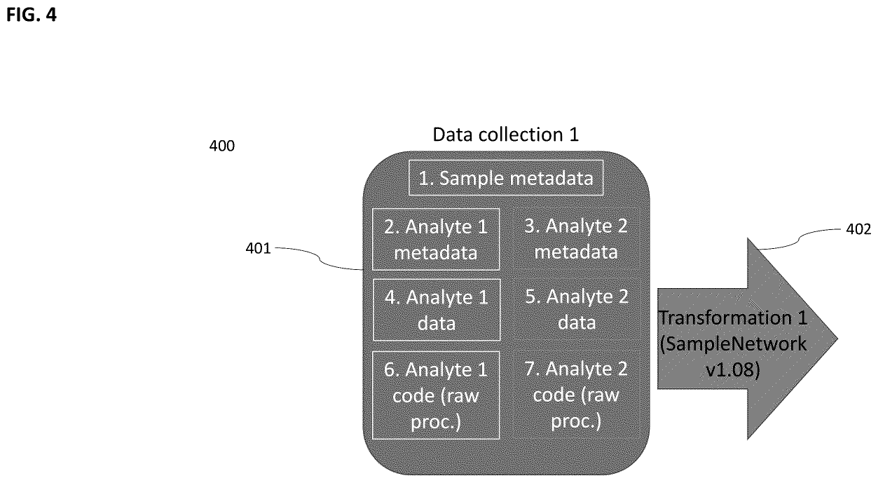

FIG. 4 presents an excerpt of an exemplary workflow according to an embodiment of the present invention. Excerpt of workflow 400 comprises data container 401 and transformation 402. Data container 401 is a data collection comprising sample metadata, metadata for Analytes 1 and 2, data for Analytes 1 and 2 as well as code, such as computer executable code, for Analytes 1 and 2. In workflow 400, container 401, including constituent elements (i.e., sample metadata, metadata for Analytes 1 and 2, data for Analytes 1 and 2 as well as code for Analytes 1 and 2) is provided as input to transformation 402.

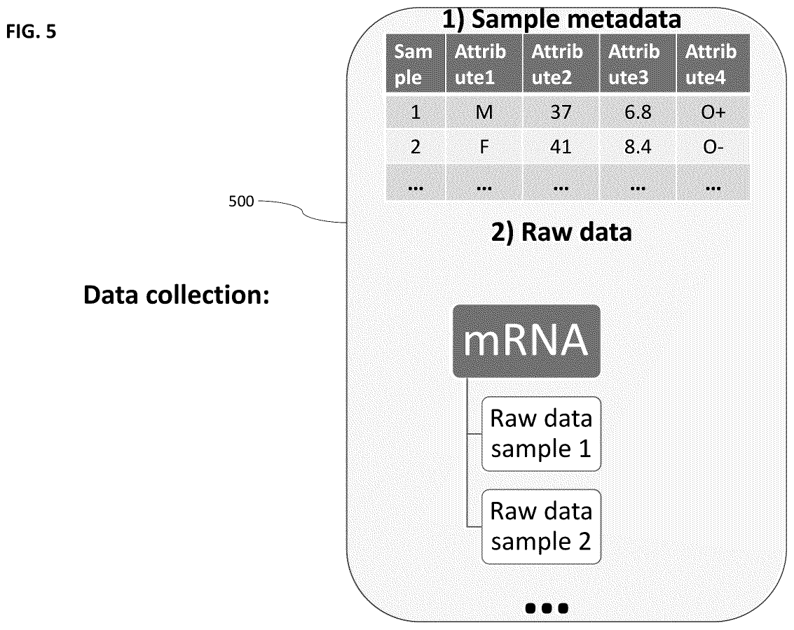

FIG. 5 presents an exemplary container according to an embodiment of the present invention. Container 500 is a data collection comprising sample metadata, comprising a series of attribute values for two raw data samples, as well as the two raw data samples themselves. The two raw data samples in container 500 are associated with mRNA data.

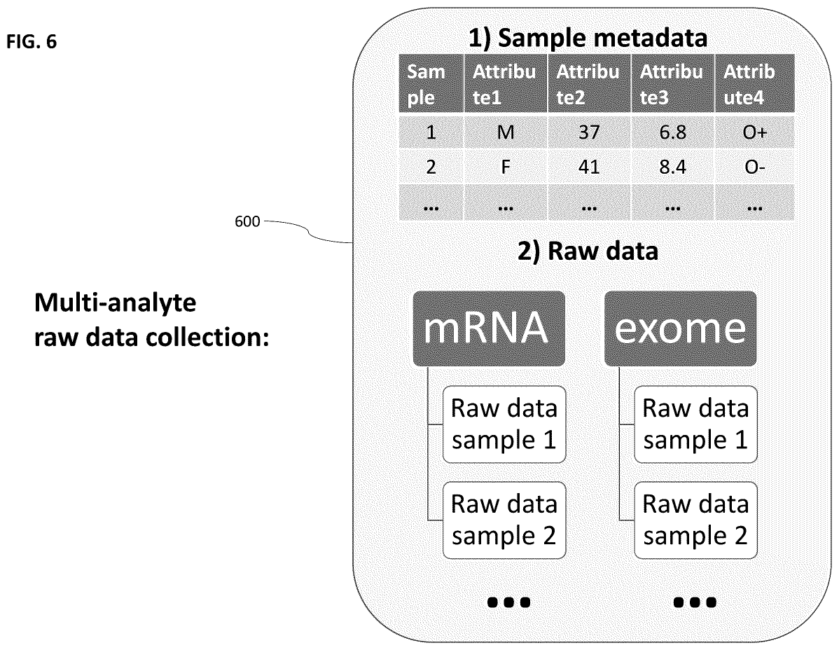

FIG. 6 presents an exemplary container according to an embodiment of the present invention. Container 600 is multi-analyte raw data container. Container 600 comprises sample metadata, comprising a series of attribute values for two raw data samples, as well as the two raw data samples themselves. The two raw data samples in container 600 are associated with mRNA data as well as exome data.

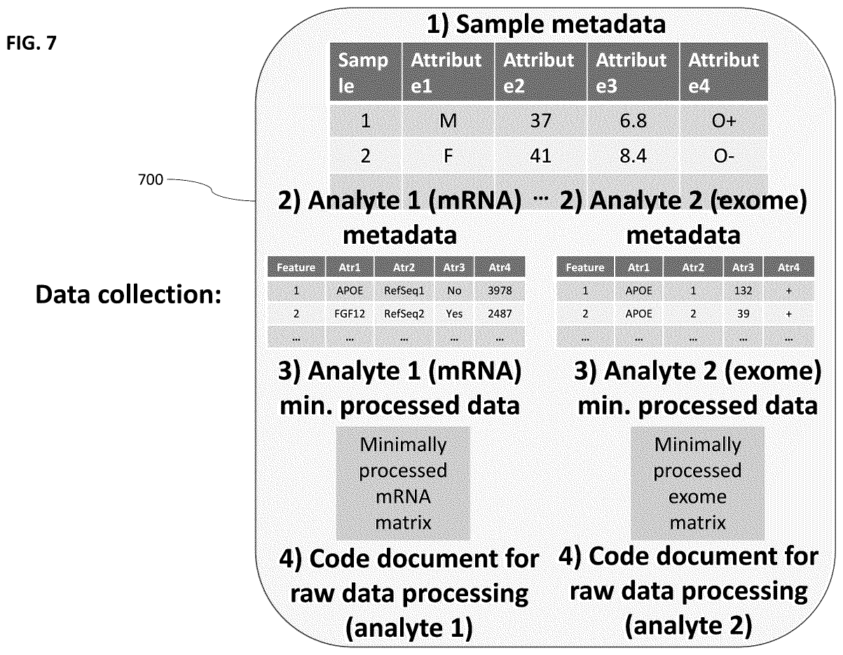

FIG. 7 presents an exemplary container according to an embodiment of the present invention. Container 700 is a data collection. Container 700 comprises sample metadata, comprising a series of attribute values for two raw data samples, as well as metadata associated with each of two analytes where the first analyte metadata is associated with mRNA and the second analyte metadata is associated with exome data. Container 700 further comprises minimally processed mRNA and exome data matrices associated with each analyte, respectively. Finally, container 700 comprises code documents for raw data processing of each of the two analytes. That is, because raw data can be very large, metadata and minimally processed data may be stored in, or otherwise associated with, a container as well as code used to perform such minimal processing.

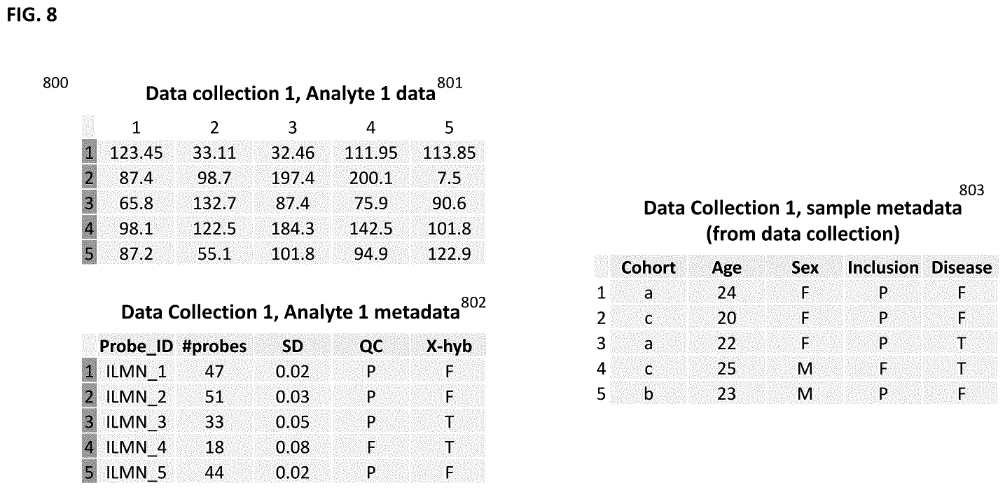

FIG. 8 presents exemplary contents of a container according to an embodiment of the present invention. Container 800 comprises table 801, table 802 and table 803. Table 801 comprises data values associated with a first analyte. Table 802 comprises metadata values associated with the first analyte corresponding to a series of probes. Table 803 comprises further metadata values associated with the sample data identifying characteristics of an experimental cohort.

### Data Access/Cloud-Based Storage:

In embodiments of the present invention, the containers comprise data accessed via a computer network. In some cases, the data comprises one or more files. In other embodiments, the containers comprise publicly available data. In still other embodiments, the containers comprise data that is not publicly available. In certain cases, the containers comprise locally stored data. In other cases, the containers comprise data stored on a private server. In embodiments, the containers comprise data stored in cloud-based storage.

### Underlying Data Sets of Containers:

As described above, containers comprise or may be associated with any information relevant to the workflow, i.e., the representation of the data analysis. In embodiments, the containers comprise data sets. In some embodiments, the containers are associated with raw data. By raw data, it is meant that the data is not processed or minimally processed, such as, for example, raw empirical data directly collected in connection with a wet lab protocol. In other embodiments, the data sets comprise bioinformatic data. In still other embodiments, the data sets comprise empirical data. In yet other embodiments, the data sets are derived from empirical data. In some cases, the data sets comprise data collected through laboratory analysis. In such cases, the laboratory analysis may comprise one or more of microarray analysis, sequencer analysis or mass spectrometer analysis. In some cases, the data sets comprise data collected through a plurality of laboratory analyses. In certain cases, the laboratory analyses were performed at different times or at different locations.

In embodiments, the data sets (i.e., data sets associated with a container or that a container comprises) comprise data that quantifies an analyte. In some embodiments, the data sets comprise raw data. In other embodiments, the data sets comprise data that is the result of data analysis. In certain cases, the data sets comprise data that is the result of bioinformatic analysis.

In embodiments, the containers comprise a first attribute linking the data set to a source of the data. In some embodiments, the containers comprise a second attribute linking the data set to an associated publication.

In embodiments, the data sets comprise genomic data. In some embodiments, the data sets comprise epigenomic data. In other embodiments, the data sets comprise transcriptomic data. In still other embodiments, the data sets comprise proteomic data. In certain embodiments, the data sets comprise reference data, such as the reference data described above. In some cases, the data sets comprise a reference genome or reference epigenomic data or reference transcriptomic data or reference proteomic data.

### Data Repositories:

Embodiments of the present invention further comprise receiving a data set for a container from a shared repository. In embodiments, receiving a data set from a shared repository comprises accessing a remote repository. In other embodiments, receiving a data set from a shared repository comprises accessing a cloud-based repository.

### Transformations:

Embodiments of the present invention further comprise: selecting one or more transformations, based on input from the user, arranging one or more graphical icons representing the one or more transformations in the graphical workflow representing the data analysis. In embodiments, the transformations comprise operations performed on at least one input data set resulting in at least one output data set. In some embodiments, the transformations comprise operations performed on at least one input container resulting in at least one output container. In other embodiments, operations performed on at least one input container resulting in at least one output container comprise analytic operations. In certain embodiments, operations performed on at least one input container resulting in at least one output container comprise bioinformatic operations. In some cases, operations performed on at least one input container resulting in at least one output container comprise computer-executable code configured to take as input one or more data containers and produce as output one or more data containers.

In embodiments, a transformation is a body of code consisting of one or more functions and associated file types (e.g., driver, parameters, environment, etc.), along with its attributes. In some embodiments, transformations consist of multiple steps and have (potentially) multiple input and output containers.

In embodiments, a pipeline is a well-defined series of transformations and containers that is stereotyped and optimized to perform a specific task, such as, for example, “preprocess raw RNA-seq reads,” along with its attributes. For illustration only and without limitation, in some cases, a pipeline may be analogous to a grammatical sentence, i.e., one or more nouns (containers) and one or more verbs (transformations). In some embodiments, a workflow is the application of one or more transformations or pipelines to one or more instances of the appropriate container type(s), along with its attributes.

### Attributes of Transformations:

In embodiments, the transformations comprise standardized metadata. In some embodiments, the standardized metadata are transformation attributes. In other embodiments, the metadata comprises annotations. In still other embodiments, the annotations comprise data annotations.

In embodiments, the transformation attributes comprise parameters that define how computer-executable code is executed. In some embodiments, the transformation comprise parameters that define aspects of the transformation.

In embodiments, transformation parameters are modifiable based on user input. In some embodiments, transformation parameters are modifiable based on user input received via a graphical user interface. In other embodiments, transformation parameters are modifiable without directly writing or modifying computer code.

In embodiments, transformations are configured to be executed in a cloud computing environment. In some embodiments, transformations are configured to be executed in a local computing environment. In other embodiments, transformations are configured to be executed in different computing environments without writing or modifying computer code.

Embodiments of the present invention further comprise annotating a transformation. As described above, transformations may be annotated with any information the user desires or deems relevant or useful. Transformation annotations are conceptually similar to container annotations, as described above, applied to transformations, not containers. Any convenient annotations may be provided, such as, for example, information about when or where or how a transformation originated, why it is used or how it is used. Annotations may take the form of structured fields, such as flags or prepopulated fields, or may take the form of unstructured fields in which a narrative description is entered. Such narrative descriptions may take the form of natural language descriptions or mathematical formulae or pseudo code or the any other form of description relevant to data or information associated with a transformation.

In embodiments, annotating a transformation comprises populating transformation attributes. In some embodiments, annotating a transformation comprises populating transformation attributes based on input received from a user. In other embodiments, annotating a transformation comprises processing input data related to a transformation. In some cases, input data related to a transformation comprises one or more of: a written description or a publication or a record of responses to questions related to the transformation.

In embodiments, annotating a transformation comprises: training a machine learning model to annotate a transformation using a description of an existing transformation and corresponding attributes of the existing transformation as training data, applying a machine learning model to a description of the transformation, and annotating the transformation based on results of applying the machine learning model. In some embodiments, annotating a transformation comprises: applying a machine learning model, trained to identify transformation attributes based on a description, to a description of the transformation, and annotating the transformation based on results of applying the machine learning model. In some embodiments, a machine learning model may comprise one or more of: a statistical model, a linear model, a computational model, a tree-based model, a convolutional neural network, an artificial neural network or a deep learning network, as such models and techniques for training and applying them are known in the art. In embodiments, a machine learning model may comprise linear and tree-based baseline models, autoML-based boosted and ensemble models, and deep learning models. In certain cases, training the machine learning model comprises one or more of: an unsupervised learning technique, a semi-supervised learning technique or a supervised learning technique, as such techniques are known in the art.

In embodiments, training a machine learning model to annotate a transformation comprises utilizing one or more of stratified sampling, held out test set, cross validation, hyper parameter tuning or random grid search. In some cases, evaluating the accuracy of annotating a transformation by the model comprises using any available technique for assessing the accuracy of the model, such as, for example, using one or more of held out test sets and cross validation evaluations. In other cases, further training the machine learning model using descriptions of existing transformations and corresponding attributes of the existing transformations comprises training the machine learning model using the plurality of descriptions of existing transformations and corresponding attributes of the existing transformations in their entirety.

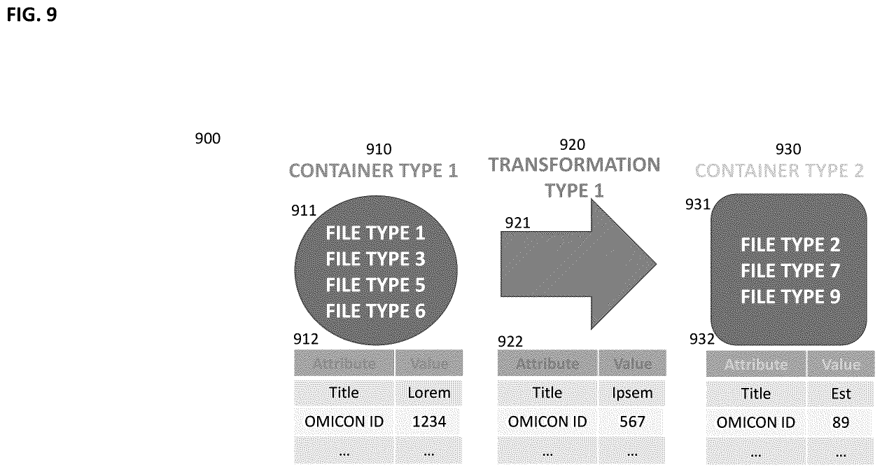

FIG. 9 presents an excerpt of an exemplary workflow according to an embodiment of the present invention. Workflow 900 comprises: container 910 that is a first type of container; container 930 that is a second type of container; as well as transformation 920 that takes its input from container 910 and generates its output into container 930. Container 910 comprises four different files 911, i.e., data associated with container 910 that is input data to transformation 920, as well as attributes 912. Container 920 comprises three different files 931, i.e., data associated with container 930 that is output data of transformation 920, as well as attributes 932. Transformation 920 comprises an operation 921, such as a statistical operation or other mathematical or computational operation, as well as attributes 922.

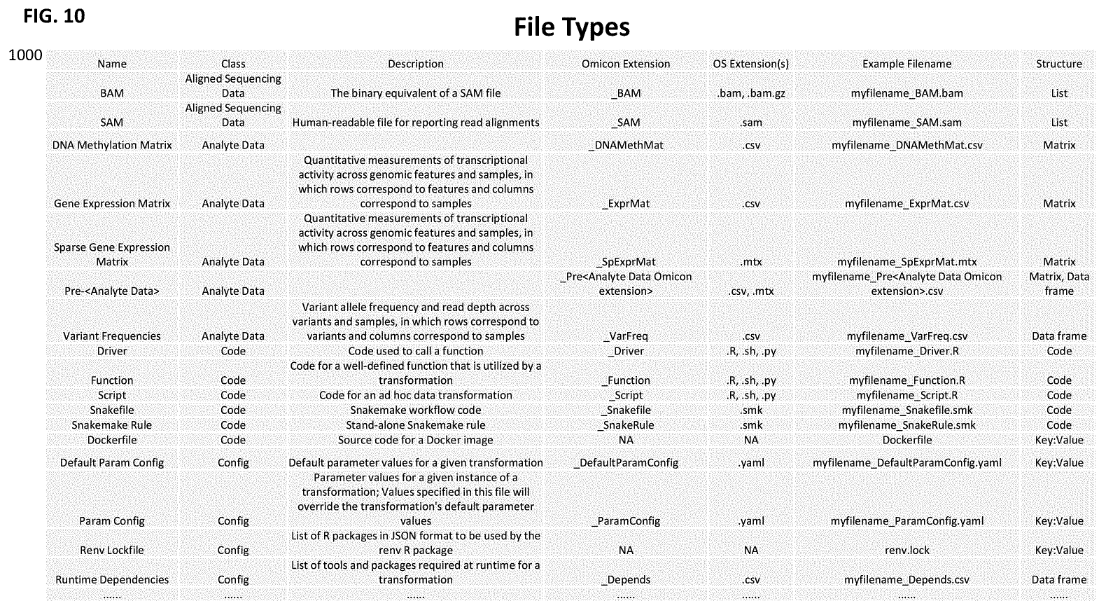

FIG. 10 presents a listing 1000 of some standardized file types that may be associated with a container or transformation, such as container 910 or transformation 920 of FIG. 9. Standardized file types are described in terms of file type names, classes, descriptions, file extension (or, in some cases, Omicon extensions insofar some embodiments of the present invention may be referred to as Omicon), OS extensions, example filenames as well as structures. File types seen in listing 1000 are a subset of exemplary file types and do not represent an exclusive list.

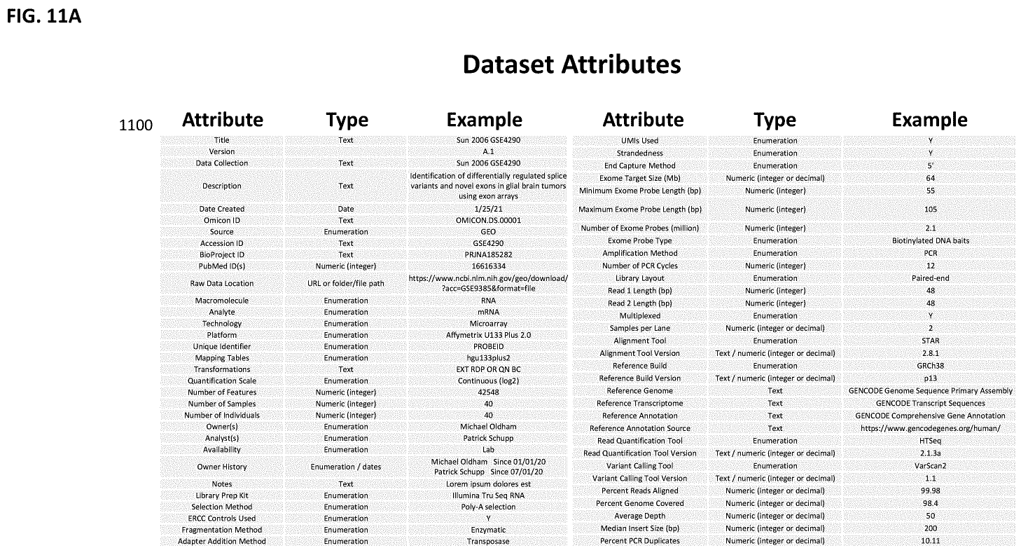

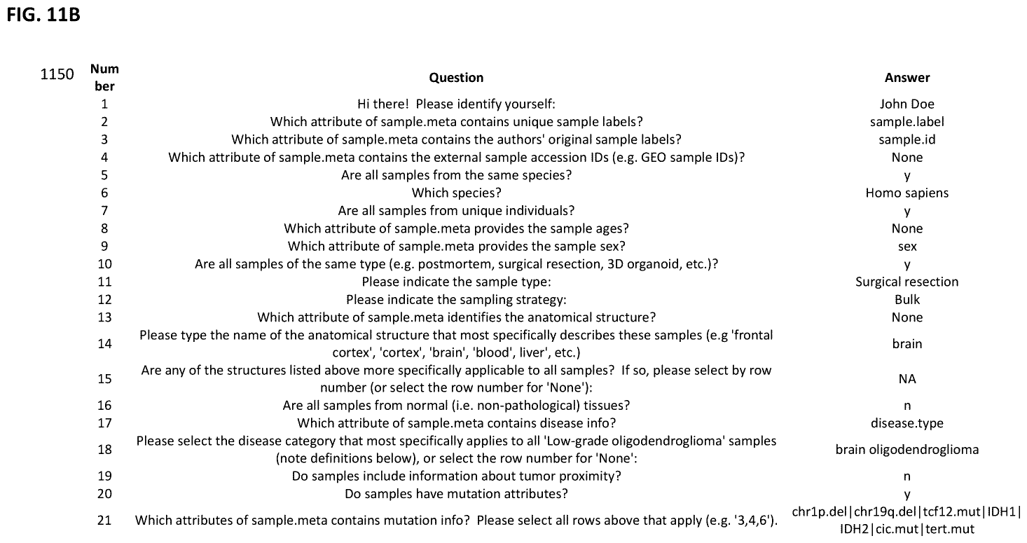

FIG. 11A presents a listing 1100 of some standardized dataset attributes that may be associated with a container or transformation, such as container 910 or transformation 920 of FIG. 9. Dataset attributes are described in terms of attribute names, attribute types as well as examples, i.e., example values. Attributes seen in listing 1100 are a subset of exemplary attributes and do not represent an exclusive list.

FIG. 11B presents a log 1150 of an automated question-answer session according to an embodiment of the present invention for use in identifying data attributes and populating attributes of a newly instantiated container. Such question-answer log 1050 may be utilized in connection with applying automated techniques for populating container attributes, such as training and utilizing machine-learning algorithms.

### Performing Data Analysis:

Embodiments of the present invention further comprise performing data analysis based on the workflow. In embodiments, performing data analysis based on the workflow comprises: applying one or more transformations present in the workflow to one or more input containers present in the workflow, and generating output results contained in one or more output containers present in the workflow, based on results of applying one or more transformations. That is, in some cases, performing a workflow comprises creating (e.g., compiling and/or linking) and executing a computer-based process or program based on the workflow in order to perform or execute one or more aspects of the data analysis represented by the workflow.

### Graphical Workflow:

Embodiments of the present invention further comprise defining transformation types or container types based on input from the user via a graphical user interface or application programming interface (API). Defining transformation types or container types may take the form of creating data operations or data structures via any convenient graphical user interface or application programming interface (API). Embodiments of the present invention further comprise importing an instance of a transformation or a container based on input from the user via a graphical user interface or application programming interface (API). That is, in some cases, a transformation or container may exist outside the present workflow or in a different context and may be imported into the present workflow in connection with representing a data analysis.

In embodiments, the graphical workflow is configured to include a plurality of different types of containers as input data. In some embodiments, the graphical workflow is configured to include a plurality of different types of containers as output data. In other embodiments, the workflow comprises a visual representation of data analysis. In still other embodiments, the workflow comprises a network of containers and transformations. In yet other embodiments, the workflow comprises a flowchart of containers and transformations.

Interacting with the Workflow:

In embodiments, the graphical workflow is an interactive graphical workflow. Some embodiments further comprise: inspecting containers or transformations of the workflow. By inspecting a container or transformation, it is meant interacting with the container or transformation in order to view data, such as metadata or attributes or input or output data, associated with the container or transformation or data associated with how or when or where a transformation was applied. In some embodiments, inspecting containers or transformations of the workflow comprises inspecting container attributes or transformation attributes. In other embodiments, inspecting containers or transformations of the workflow comprises inspecting an underlying data set associated with one or more containers or transformations. In still other embodiments, inspecting containers or transformations of the workflow comprises inspecting an underlying file associated with one or more containers or transformations. In some cases, inspecting attributes of a container or a transformation of the workflow comprises hovering a cursor over a representation of a container or a transformation in the graphical workflow.

Embodiments of the present invention further comprise inspecting intermediate results in the workflow. By intermediate results, it is meant, for example, one or more containers that comprise outputs of one or more transformations but do not represent final results of the workflow. In certain cases, inspecting intermediate results in a workflow comprises inspecting an intermediate container. In other cases, inspecting intermediate results in a workflow comprises hovering a cursor over a representation of a container in the graphical workflow. That is, a user may control an interactive element such as a cursor to hover over an aspect of a workflow, such as a container or transformation that the user desires to inspect.

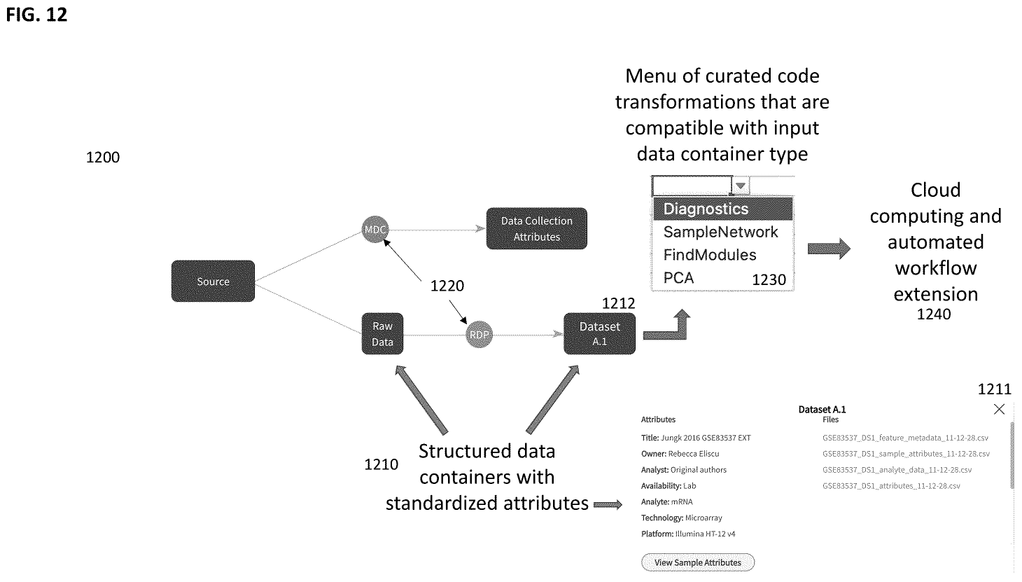

FIG. 12 presents an excerpt of an exemplary workflow according to an embodiment of the present invention. Workflow 1200 is a directed graph with nodes comprising containers 1210 and transformations and directed edges therebetween. Containers 1210 may be inputs to transformation, outputs of transformations or both. Containers 1210 are related to, for example, data sets or raw data. Containers 1210 are structured, i.e., standardized containers, comprising standardized attributes 1211. Container attributes 1211 may be displayed when a user clicks on or hovers a cursor over or otherwise selects a container of containers 1210 for inspection. Containers 1210 are modular in the sense that they can be used in workflow 1200 with different transformations in order to build workflow 1200. Dropdown menu 1230 indicates a selection of potential transformations that are compatible with container 1212 in workflow 1200, such that the user, when building workflow 1200 could interact with a series of dropdown menus, such as dropdown menu 1230, to assemble the workflow 1200. Such aspects of embodiments of the invention help facilitate building meaningful workflows correctly and completely. In some cases, the user may desire to use workflow 1200 to perform or execute the data analysis represented by workflow 1200. In such cases, the user has the option of identifying cloud computing or automated workflow extensions 1240 for use in connection with using workflow 1200 to perform data analysis.

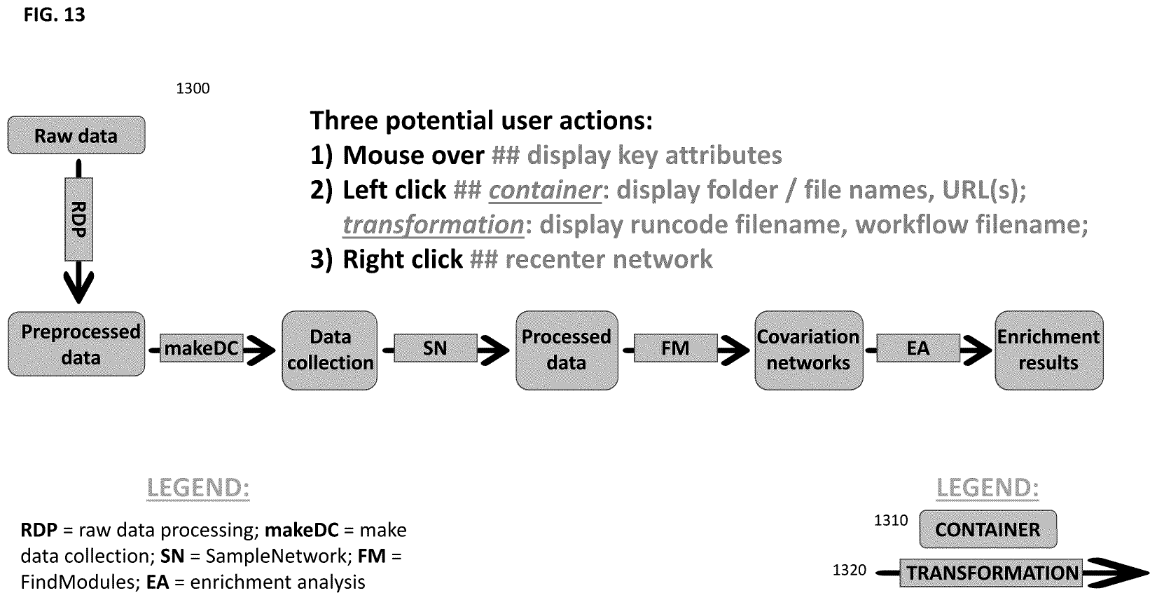

FIG. 13 presents an excerpt of an exemplary workflow according to an embodiment of the present invention. Workflow 1300 is a directed graph with nodes comprising containers 1310 and transformations 1320 with directed edges therebetween. Containers 1310 may be inputs to transformation, outputs of transformations or both. Containers 1310 are related to, for example, raw data, preprocessed data, data collections, covariation networks or enrichment results.

Containers 1310 are structured, i.e., standardized containers, comprising standardized attributes, some of which may be defined as key attributes. Transformations 1320 are related to, for example, raw data processing, making a data collection, performing SampleNetwork or FindModules functionalities or enrichment analysis. A user may interact with workflow 1300 in various ways. For example, a user may move a cursor over (e.g., mouse over) a container 1310 or transformation 1320 to cause key attributes of a container 1310 or transformation 1320 to be displayed. In another example, a user may left click on a container 1310 to cause the display of a folder or files associated with the container or URLs or other unique identifiers associated with contents of a container. In another example, a user may left click on a transformation 1320 to cause the display of a runcode filename or a workflow filename associated with the transformation. In another example, a user may right click an area of workflow 1300 to cause workflow 1300 to be recentered within a user display.

Embodiments of the present invention further comprise downloading contents of the workflow. By contents of the workflow, it is meant any desired information related to the workflow, such as data associated with one or more containers or transformations or an arrangement of one or more subsections of a workflow, such as a subnetwork of containers and transformations. In embodiments, downloading contents of the workflow comprises downloading contents of a workflow from a remote computer. In some embodiments, downloading contents of the workflow comprises downloading contents of a workflow to a local computer. In other embodiments, downloading contents of the workflow comprises downloading files from specific containers or transformations of the workflow. Embodiments of the present invention further comprise downloading contents of the workflow based on input received from the user. In embodiments, the input received from the user comprises: hovering a cursor over a representation of the entire workflow or individual containers or transformations of the workflow, presenting to the user one or more links of associated files for downloading, and clicking on a link to download associated files.

Embodiments of the present invention further comprise communicating with one or more collaborators through the workflow. By collaborators, it is meant one or more individuals that have been granted access to interact with the workflow, i.e., by the user or in addition to the user. In embodiments, annotating the workflow comprises commenting on one or more containers or transformations of the workflow based on input received from the user or a collaborator. In some embodiments, annotating the workflow comprises providing undirected or directed comments on the workflow or on one or more containers or transformations thereof. In other embodiments, communicating through the workflow comprises uploading a file to the workflow, wherein the file is associated with the workflow or one or more containers or transformations thereof. In some cases, the file comprises a media file. In other cases, the media file comprises one or more of: text, images, figures, spreadsheets, slide presentations, audio recordings, video recordings, computer code or hyperlinks.

Embodiments of the present invention further comprise: collaborating with one or more collaborators through the workflow. In embodiments, collaborating through the workflow comprises providing shared access to the workflow to one or more collaborators. In some embodiments, the workflow is associated with an owner of the workflow, and providing shared access to the workflow to one or more collaborators is allowed by the owner of the workflow. In other embodiments, collaborating through the workflow comprises one or more of: inviting a collaborator to collaborate, creating a shared task list and descriptions thereof and tracking progress of shared tasks, in each case, based on input received from the user or the one or more collaborators.

In embodiments, collaborating through the workflow comprises attributing contributions to the workflow to the user or one or more collaborators, wherein such attribution of contributions is agreed upon by the user and the one or more collaborators, based on input received from the user and the one or more collaborators. By attributing contributions, it is meant that the invention or creation or development or success of one or more aspects of the workflow are attributed to the user or one or more collaborators. In other words, credit for an aspect of the workflow is assigned to the user or one or more collaborators. In some embodiments, attribution of contributions is agreed upon based on input received via a graphical user interface. In other embodiments, attribution of contributions are agreed upon based on a consensus among the user and the one or more collaborators. In still other embodiments, attribution of contributions is agreed upon by the user and the one or more collaborators according to a specified formula or algorithm. In some cases, attribution of contributions are used to establish proportional claims among the user and the one or more collaborators to intellectual property associated with the workflow.

Embodiments of the present invention further comprise: creating, copying, and modifying the workflow. In embodiments, creating the second workflow comprises: dragging and dropping, selecting or highlighting one or more containers or transformations. In some embodiments, creating the second workflow comprises partially or entirely copying the workflow. In other embodiments, creating the second workflow comprises modifying the workflow. Some embodiments of the present invention further comprise: importing a previously created workflow as the workflow. Other embodiments of the present invention further comprise: sharing the workflow. In embodiments, sharing the workflow comprises inviting one or more collaborators to share the workflow. In some embodiments, sharing the workflow comprises setting a workflow attribute.

In embodiments, sharing the workflow comprises submitting the workflow for verification to a validator network. By validator network, it is meant a third party capable of validating a representation of a workflow. Validator networks may comprise a central authority or a distributed network. Validator networks may function by keeping records of representations of workflows submitted to the validator network as well as associated information related to or enabling authenticating the representation of the workflow. In certain embodiments, sharing the workflow comprises contributing a representation of the workflow to a blockchain. In other embodiments, sharing the workflow comprises sharing a hyperlink containing a permanent DOI or accession ID or other unique identifier associated with the workflow. In still other embodiments, sharing the workflow comprises sharing the workflow under a specific license or specific terms governing conditions of use. Any convenient or desired license or terms may be applied such as, for example, one or more licenses promulgated by the Creative Commons.

### Reproducibility:

Embodiments of the present invention further comprise: using the workflow to reproduce a data analysis. Other embodiments of the present invention further comprise: reproducing a data analysis using a previously created workflow. Still other embodiments of the present invention further comprise: selecting input data comprising a second input data set, based on a third input from a user, and performing data analysis based on the workflow applied to the second input data set. In embodiments, performing data analysis based on the workflow comprises executing workflows in whole or in part in a specified computing environment. In some cases, the specified computing environment comprises a cloud computing environment or a remote computing environment or a local computing environment. Embodiments of the present invention further comprise: verifying that containers, transformations, or workflows contain expected, unmodified information. Any convenient technique for verifying data authenticity, i.e., that data has not been unexpectedly modified, may be applied, such as generating and comparing checksum values or generating and comparing hash values or other techniques known in the art.

### Data Verification:

Embodiments of the present invention further comprise: generating a checksum value for one or more containers, one or more transformations or the workflow. Other embodiments of the present invention further comprise: verifying the integrity of the one or more containers, the one or more transformations, or the workflow by comparing the checksum value against a reference value. In embodiments, generating a checksum value comprises a hash value. Still other embodiments of the present invention further comprise: utilizing a blockchain to verify integrity of input data. Even other embodiments of the present invention further comprise: utilizing a validator network to verify integrity of the workflow. Any convenient blockchain technology, as such are known in the art, may be applied in connection with verifying the integrity of a workflow.

### Data Collection Protocols:

In embodiments, the workflow further comprises standardized representations of steps taken to generate data. For example, the workflow may comprise information relating to empirical or wet lab protocols used to collect data sets present in, or referenced by, the workflow. While the workflow itself is an in silico representation of data analysis, the user may wish to include information related to how a data set was generating in a laboratory to more completely illustrate an experimental method, of which the data analysis is a constituent part, or for use in comparing one experimental method versus alternative experimental methods, for example. In some embodiments, containers comprise attributes related to protocols used to collect data associated with the containers.

### Distributed Computation:

In embodiments, performing data analysis based on the workflow comprises locally performing computations. In some embodiments, performing data analysis based on the workflow comprises remotely performing computations. In other embodiments, remotely performing computations comprises utilizing shared computing resources. In still other embodiments, remotely performing computations comprises utilizing cloud-based resources.

### Search:

As described above, in embodiments, containers and/or transformations comprise attributes, which may be standardized metadata fields associated with containers and/or transformations. In some embodiments, the transformations and containers comprise searchable attributes. By searchable attributes, it is meant that the user is able to interact with, for example, a graphical user interface, by presenting desired characteristics of a container or transformation thereby effecting a search of available containers or transformations with attributes associated with the desired characteristics. Embodiments of the present invention further comprise: searching a repository of containers or transformations based on specified container or transformation attributes. Other embodiments of the present invention further comprise: searching a repository of containers or transformations based on accession IDs or DOIs or other unique identifiers. Still other embodiments of the present invention further comprise: saving search queries based on input received from a user through a dedicated interface. Embodiments of the present invention further comprise: maintaining a repository of containers or transformations, wherein the repository is searchable based on specified container or transformation attributes. In some cases, selecting containers or transformations for data analysis comprises utilizing the results of searching the repository.

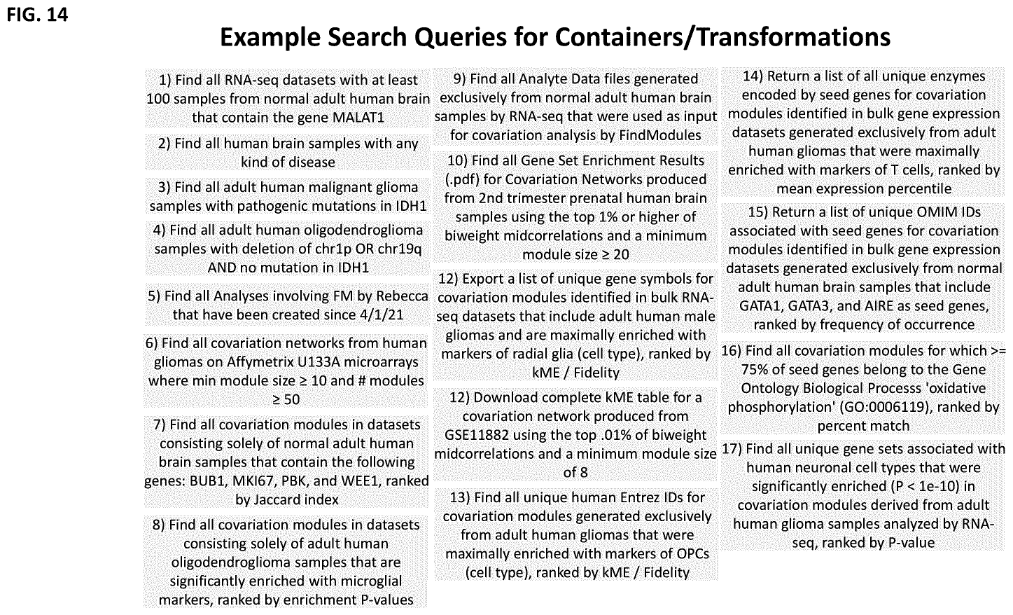

FIG. 14 presents example search queries that may be addressed to an embodiment of the present invention configured to enable searching of containers or attributes. Search queries 1400 involve querying for containers or for transformations and in some cases provide highly detailed characteristics regarding the desired container or transformation. Embodiments of the present invention are configured to associate relevant attributes with containers and transformations to reflect search characteristics such as those specified in queries 1400. Embodiments of the present invention may further comprise providing an interface for receiving search queries, such as queries 1400, and for searching a repository or database or other data storage for applicable containers or transformations. Any convenient search query may be applied in such embodiments and are not limited to queries 1400.

### Further Exemplary Embodiments

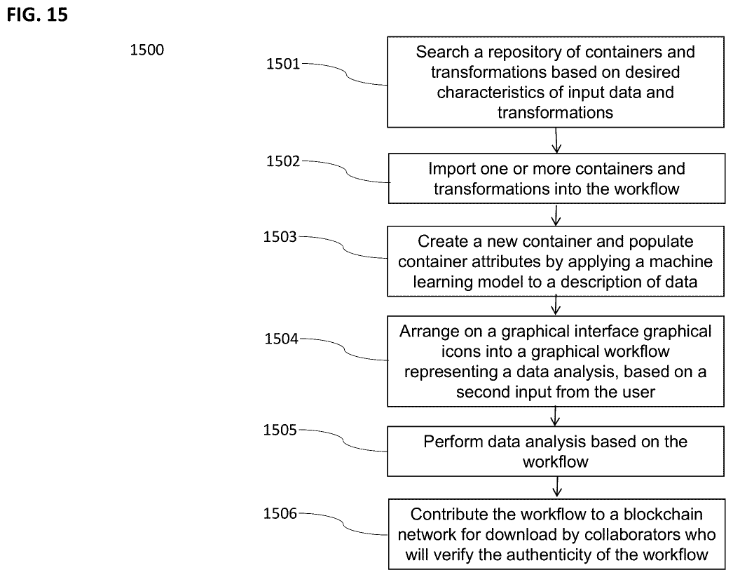

FIG. 15 is a flow diagram illustrating one embodiment of a method of the present invention. Flow diagram 1500 illustrates a subset of the diverse range of functionalities enabled by embodiments of the present invention in connection with building a workflow of containers and transformations in order to represent, store and retrieve components of, act upon components of, and perform data analysis. Flow diagram 1500 starts at step 1501.

At step 1501, the user interacts with a graphical user interface to search a repository of containers and transformations based on desired characteristics of input data and transformations. Such desired characteristics are reflected in attribute values of available containers and transformations held in the repository. Any convenient technique may be used to create and maintain such repository and such may be a database. Upon completion of step 1501, flow diagram 1500 next moves to step 1502.

At step 1502, the user interacts with a graphical user interface to import one or more containers and transformations into the workflow. Such container and transformation may be imported from the repository referenced in step 1501 or another source, such as, for example, a previously created workflow stored locally or remotely. Upon completion of step 1502, flow diagram 1500 next moves to step 1503.

At step 1503, the user interacts with a graphical user interface to create a new container and populate such newly created container attributes by applying a machine learning model to a description of data. Any convenient machine learning model may be applied, and such machine learning model may be trained based on previously populated attributes of previously created containers to automatically populate container attributes. Container attributes may be populated using any convenient description of data associated with the newly created container, such as a publication, such as an academic work, or an informal written description or responses to a series of questions, e.g., automatically generated questions. Upon completion of step 1503, flow diagram 1500 next moves to step 1504.

At step 1504, the user interacts with a graphical user interface to arrange on such graphical interface graphical icons into a graphical workflow representing a data analysis. The user may arrange such icons by, for example, moving them using a mouse in a manner that is similar to arranging icons in a picture. Upon completion of step 1504, flow diagram 1500 next moves to step 1505.

At step 1505, data analysis based on the workflow is performed. That is, the operations defined by the various workflow transformations are performed in a sequential basis, based on the order they are arranged in the graphical workflow, using data associated with the various containers present in the workflow. That is, each transformation has associated with it at least one input container and at least on output container, such that each transformation performs an operation (e.g., a mathematical function) on input data associated with an input container and stores the results of such operation in the associated output container. At the end of performing the data analysis, the final containers (e.g., rightmost as in FIG. 3) are populated with results of performing the data analysis defined by the workflow. Upon completion of step 1505, flow diagram 1500 next moves to step 1506.

At step 1506, the user interacts with a graphical user interface to contribute the workflow to a blockchain network. That is, the user stores a copy of the workflow associated with a blockchain such that the version stored in the blockchain establishes a fixed, reference version of the workflow, available for download by collaborators who can use functionality available through storage in the blockchain to verify the authenticity of the workflow. By verify the authenticity of the workflow, it is meant that a subsequently downloaded copy of the workflow is unmodified as compared with the version of the workflow that was contributed to the blockchain. Upon completion of step 1506, flow diagram 1500 ends.

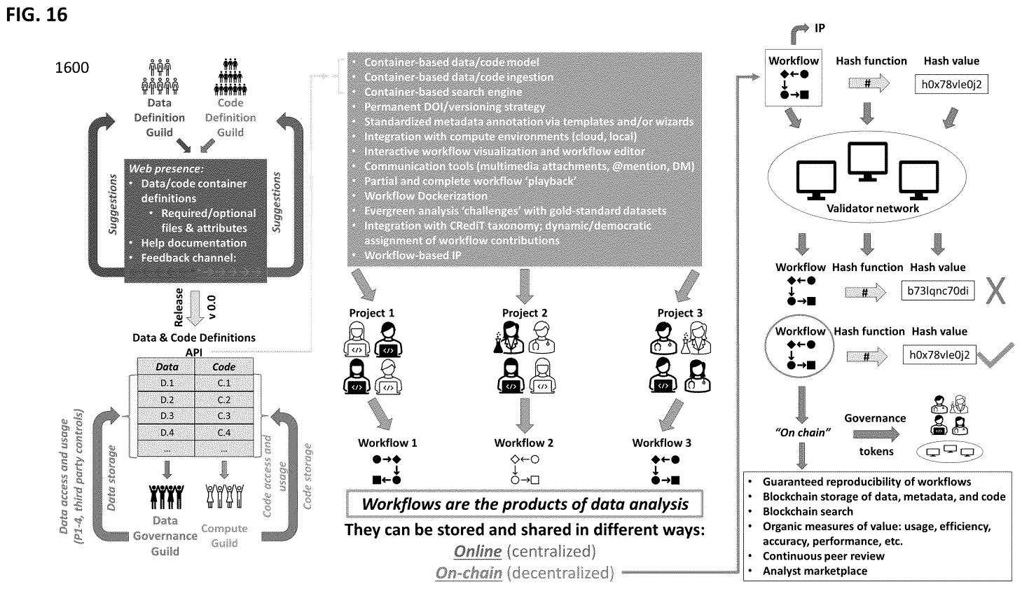

FIG. 16 presents various example tasks 1600 illustrating how embodiments of the present invention may be used and how such embodiments facilitate representing data analyses in a manner that facilitates, in particular, the generation of reproducible results. The various tasks 1600 include defining how containers and/or transformations may be defined and populated with relevant information. The various tasks 1600 further include utilizing containers and transformations to generate different workflows by groups of users collaborating. Such different workflows can then be submitted to a validator network, at which various functionality is employed to ensure the authenticity of the different workflows is maintained, including utilizing blockchain technology and hash functions, as such are known in the art.

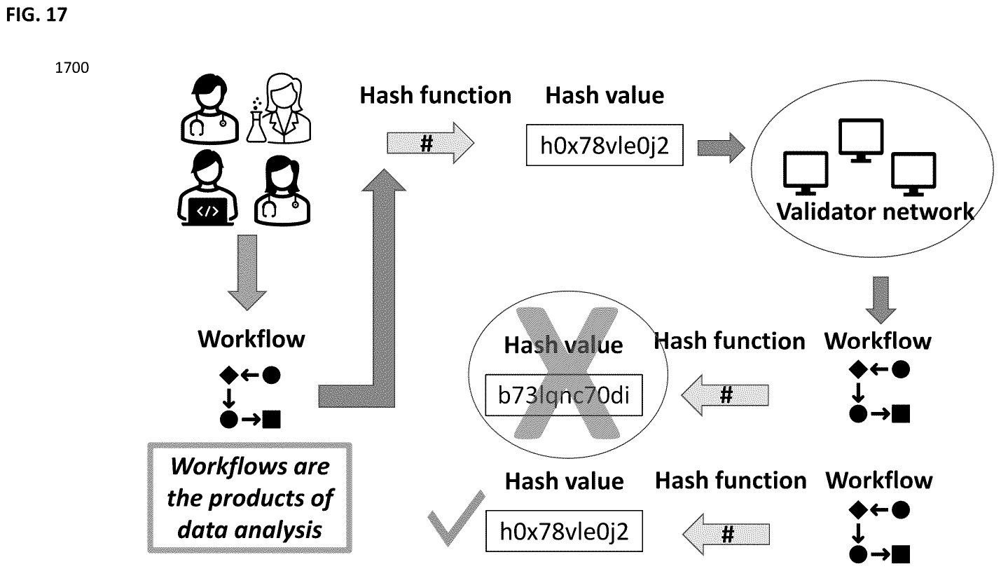

FIG. 17 presents an exemplary data validation process 1700 for workflows. Once a user and collaborators generate a workflow to represent a desired data analysis, the authenticity of such workflow may be confirmed by submitting a copy of the workflow to a validator network along with a hash value generated by hashing one or more aspects of the original workflow. Hash values may be generated in an identical manner for subsequently downloaded or otherwise utilized workflows. Comparing such subsequently generated hash values against the original hash value provides confirmation whether the subsequently downloaded or otherwise utilized workflow is identical to the original workflow or not.

### Computer Implemented Embodiments

The various method and algorithm steps described in connection with the embodiments disclosed herein can be implemented as electronic hardware, computer software, or combinations of both. To clearly illustrate this interchangeability of hardware and software, various illustrative steps have been described above generally in terms of their functionality. Whether such functionality is implemented as hardware or software depends upon the particular application and design constraints imposed on the overall system applying a method according to the present disclosure. The described functionality can be implemented in varying ways for each particular application, but such implementation decisions should not be interpreted as causing a departure from the scope of the disclosure.

The various illustrative steps, components, and computing systems (such as devices, databases, interfaces, and engines) described in connection with the embodiments disclosed herein can be implemented or performed by a machine, such as a general purpose processor, a graphics processor unit, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor can also include primarily analog components. A computing environment can include any type of computer system, including, but not limited to, a computer system based on a microprocessor, a graphics processor unit, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module, engine, and associated databases can reside in memory resources such as in RAM memory, FRAM memory, flash memory, ROM memory, EPROM memory, EEPROM memory, registers, hard disk, a removable disk, a CD-ROM, or any other form of non-transitory computer-readable storage medium, media, or physical computer storage known in the art. An external storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

### Systems for Representing Data Analysis

As summarized above, aspects of the present disclosure include systems for representing data analysis. Systems according to certain embodiments comprise a processor comprising memory operably coupled to the processor, wherein the memory comprises instructions stored thereon, which, when executed by the processor, cause the processor to execute steps corresponding to the subject methods described herein.

In some embodiments of systems according to the present disclosure comprise: a processor comprising memory operably coupled to the processor, wherein the memory comprises instructions stored thereon, which, when executed by the processor, cause the processor to: select input data comprising standardized data containers, based on a first input from a user; and arrange on a graphical interface graphical icons into a graphical workflow representing a data analysis, based on a second input from the user, wherein the workflow comprises a plurality of standardized data transformations and standardized data containers comprising intermediate and final results of the data analysis.

In embodiments of systems according to the present disclosure, the memory further comprises instructions stored thereon, which, when executed by the processor, cause the processor to: select one or more containers, based on input from the user, and arrange one or more graphical icons representing the one or more containers in the graphical workflow representing the data analysis.

In some embodiments of systems according to the present disclosure, the memory further comprises instructions stored thereon, which, when executed by the processor, cause the processor to: define types of containers or transformations or attributes, based on input received from the user. In other embodiments of systems according to the present disclosure, the memory further comprises instructions stored thereon, which, when executed by the processor, cause the processor to: create new containers or transformations or attributes by importing one or more data set or analytical operation, based on input received from the user. In still other embodiments of systems according to the present disclosure, the memory further comprises instructions stored thereon, which, when executed by the processor, cause the processor to: annotate a container.

In embodiments of systems according to the present disclosure, the memory further comprises instructions stored thereon, which, when executed by the processor, cause the processor to: receive a data set for a container from a shared repository. In some embodiments of systems according to the present disclosure, the memory further comprises instructions stored thereon, which, when executed by the processor, cause the processor to: select one or more transformations, based on input from the user, and arrange one or more graphical icons representing the one or more transformations in the graphical workflow representing the data analysis. In other embodiments of systems according to the present disclosure, the memory further comprises instructions stored thereon, which, when executed by the processor, cause the processor to: annotate a transformation. In still other embodiments of systems according to the present disclosure, the memory further comprises instructions stored thereon, which, when executed by the processor, cause the processor to: perform data analysis based on the workflow.

In embodiments of systems according to the present disclosure, the memory further comprises instructions stored thereon, which, when executed by the processor, cause the processor to: apply one or more transformations present in the workflow to one or more input containers present in the workflow, and generate output results contained in one or more output containers present in the workflow, based on results of applying one or more transformations. In some embodiments of systems according to the present disclosure, the memory further comprises instructions stored thereon, which, when executed by the processor, cause the processor to: define transformation types or container types based on input from the user via a graphical user interface or application programming interface (API). In other embodiments of systems according to the present disclosure, the memory further comprises instructions stored thereon, which, when executed by the processor, cause the processor to: import an instance of a transformation or a container based on input from the user via a graphical user interface or application programming interface (API). In still other embodiments of systems according to the present disclosure, the memory further comprises instructions stored thereon, which, when executed by the processor, cause the processor to: inspect containers or transformations of the workflow.

In embodiments of systems according to the present disclosure, the memory further comprises instructions stored thereon, which, when executed by the processor, cause the processor to: inspect intermediate results in the workflow.

In some embodiments of systems according to the present disclosure, the memory further comprises instructions stored thereon, which, when executed by the processor, cause the processor to: download contents of the workflow, in some cases based on input received from the user. In other embodiments of systems according to the present disclosure, the memory further comprises instructions stored thereon, which, when executed by the processor, cause the processor to: communicate with one or more collaborators through the workflow. In still other embodiments of systems according to the present disclosure, the memory further comprises instructions stored thereon, which, when executed by the processor, cause the processor to: collaborate with one or more collaborators through the workflow.

In embodiments of systems according to the present disclosure, the memory further comprises instructions stored thereon, which, when executed by the processor, cause the processor to: generate a second workflow by creating, copying, and modifying the workflow. In some embodiments of systems according to the present disclosure, the memory further comprises instructions stored thereon, which, when executed by the processor, cause the processor to: import a previously created workflow as the workflow. In other embodiments of systems according to the present disclosure, the memory further comprises instructions stored thereon, which, when executed by the processor, cause the processor to: share the workflow. In still other embodiments of systems according to the present disclosure, the memory further comprises instructions stored thereon, which, when executed by the processor, cause the processor to: use the workflow to reproduce a data analysis.

In embodiments of systems according to the present disclosure, the memory further comprises instructions stored thereon, which, when executed by the processor, cause the processor to: reproduce a data analysis using a previously created workflow. In some embodiments of systems according to the present disclosure, the memory further comprises instructions stored thereon, which, when executed by the processor, cause the processor to: select input data comprising a second input data set, based on a third input from a user, and perform data analysis based on the workflow applied to the second input data set. In other embodiments of systems according to the present disclosure, the memory further comprises instructions stored thereon, which, when executed by the processor, cause the processor to: use the workflow to reproduce a data analysis. In still embodiments of systems according to the present disclosure, the memory further comprises instructions stored thereon, which, when executed by the processor, cause the processor to: reproduce a data analysis using a previously created workflow.

In embodiments of systems according to the present disclosure, the memory further comprises instructions stored thereon, which, when executed by the processor, cause the processor to: select input data comprising a second input data set, based on a third input from a user, and perform data analysis based on the workflow applied to the second input data set. In some embodiments of systems according to the present disclosure, the memory further comprises instructions stored thereon, which, when executed by the processor, cause the processor to: verify that containers, transformations, or workflows contain expected, unmodified information. In other embodiments of systems according to the present disclosure, the memory further comprises instructions stored thereon, which, when executed by the processor, cause the processor to: generate a checksum value for one or more containers, one or more transformations or the workflow. In still other embodiments of systems according to the present disclosure, the memory further comprises instructions stored thereon, which, when executed by the processor, cause the processor to: verify the integrity of the one or more containers, the one or more transformations, or the workflow by comparing the checksum value against a reference value.

In embodiments of systems according to the present disclosure, the memory further comprises instructions stored thereon, which, when executed by the processor, cause the processor to: utilize a blockchain to verify integrity of input data. In some embodiments of systems according to the present disclosure, the memory further comprises instructions stored thereon, which, when executed by the processor, cause the processor to: search a repository of containers or transformations based on specified container or transformation attributes. In other embodiments of systems according to the present disclosure, the memory further comprises instructions stored thereon, which, when executed by the processor, cause the processor to: search a repository of containers or transformations based on accession IDs or DOIs or other unique identifiers. In still embodiments of systems according to the present disclosure, the memory further comprises instructions stored thereon, which, when executed by the processor, cause the processor to: save search queries based on input received from a user through a dedicated interface.

In embodiments of systems according to the present disclosure, the memory further comprises instructions stored thereon, which, when executed by the processor, cause the processor to: maintain a repository of containers or transformations, wherein the repository is searchable based on specified container or transformation attributes.

As described in more detail below, in embodiments, the system further comprises a network interface operably connected with the processor. As described in more detail below, in some embodiments, the system further comprises an output device operably connected with the processor. In some cases, the output device is a display device. In other cases, the output device is configured to display representations of the plurality of data streams.

As described in more detail below, in embodiments, the system further comprises an input device operably connected with the processor. In some embodiments, the input device is one or more of: a keyboard, a mouse or a touchscreen. In some embodiments, the input device is configured to receive curation input from a curator. In certain embodiments, the input device is configured to receive a selection of one or more of the plurality of data streams from a curator. In embodiments, the system is a tablet device or a smartphone.

In embodiments, the system includes an input module, a processing module and an output module. The subject systems may include both hardware and software components, where the hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms of the system.

Systems may include a display and operator input device. Operator input devices may, for example, be a keyboard, mouse, or the like. The processing module includes a processor, which has access to a memory having instructions stored thereon for performing the steps of the subject methods. The processing module may include an operating system, a graphical user interface (GUI) controller, a system memory, memory storage devices, input-output controllers, cache memory, a data backup unit and many other devices. The processor may be a commercially available processor, or it may be one of other processors that are or will become available. The processor executes the operating system and the operating system interfaces with firmware and hardware in a well-known manner and facilitates the processor in coordinating and executing the functions of various computer programs that may be written in a variety of programming languages, such as Java, Perl, Python, C, C++, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques. The processor may be any suitable analog or digital system or combination thereof.

Some embodiments may further comprise a display device, e.g., for displaying results of representing, processing, searching or the like. Any convenient display device, such as a liquid crystal display (LCD), light-emitting diode (LED) display, plasma (PDP) display, quantum dot (QLED) display or cathode ray tube display device. The processor and/or memory may be operably connected to the display device, for example, via a wired, such as a Universal Serial Bus (USB) connection, or wireless connection, such as a Bluetooth connection.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disc drive, a tape drive, a removable hard disc drive, or a diskette drive. Such types of memory storage devices typically read from, and/or write to, a program storage medium, such as, respectively, a compact disc, magnetic tape, removable hard disk or floppy diskette. Any of these program storage media, or others now in use or that may later be developed, are of interest in connection with embodiments of systems of the invention. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor, causes the processor to perform functions described herein, e.g., steps of the methods described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the processor can store and retrieve data, such as magnetic, optical, or solid-state storage devices (including magnetic or optical disks or tape or RAM, or any other suitable device, either fixed or portable). The processor may include a general-purpose digital microprocessor suitably programmed from a computer readable medium carrying necessary program code. Programming can be provided remotely to the processor through a communication channel, or previously saved in a computer program product such as memory or some other portable or fixed computer readable storage medium using any of those devices in connection with memory. For example, a magnetic or optical disc may carry the programming and can be read by a disc writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium and magnetic tape; optical storage media such as CD-ROM; electrical storage media such as RAM and ROM; portable flash drive; and hybrids of these categories such as magnetic/optical storage media.

The processor may also have access to a communication channel to communicate with a user, including, a user at a remote location. By remote location is meant the user is not directly in contact with the system and relays input information to an input manager from an external device, such as a computer, such as, for example, a smartphone or tablet or laptop computer or desktop computer, connected to a Wide Area Network (“WAN”), telephone network, satellite network or any other suitable communication channel, including a mobile telephone (i.e., smartphone).

In some embodiments, systems according to the present disclosure may be configured to include a communication interface, such as, for example, a network interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, WiFi, infrared, wireless Universal Serial Bus (USB), Ultra Wide Band (UWB), Bluetooth® communication protocols, and cellular communication, such as code division multiple access (CDMA) or Global System for Mobile communications (GSM).

In one embodiment, the communication interface is configured to include one or more communication ports, e.g., physical ports or interfaces such as a USB port, an RS-232 port or any other suitable electrical connection port to allow data communication between a subject system and other external devices such as a computer terminal or other devices (for example, devices recording and/or broadcasting an event) that is configured for similar complementary data communication.

In one embodiment, the communication interface is configured for infrared communication, Bluetooth® communication, or any other suitable wireless communication protocol to enable a subject system to communicate with other devices such as computer terminals and/or networks, communication enabled mobile telephones, personal digital assistants, or any other communication devices which the user may use in conjunction with practicing the methods of the present invention.

In one embodiment, the communication interface is configured to provide a connection for data transfer utilizing Internet Protocol (IP) through a cell phone network, Short Message Service (SMS), wireless connection to a personal computer (PC) on a Local Area Network (LAN) which is connected to the internet, or WiFi connection to the internet at a WiFi hotspot.

In one embodiment, the subject systems are configured to wirelessly communicate with a server device via the communication interface, e.g., using a common standard such as 802.11 or Bluetooth® RF protocol, or an IrDA infrared protocol. The server device may be another portable device, such as a smartphone, Personal Digital Assistant (PDA) or notebook computer; or a larger device such as a desktop computer, appliance, etc. In some embodiments, the server device has a display, such as a liquid crystal display (LCD), as well as an input device, such as buttons, a keyboard, mouse or touch-screen.

In some embodiments, the communication interface is configured to automatically or semi-automatically communicate data stored in the subject systems, e.g., in an optional data storage unit, with a network or server device using one or more of the communication protocols and/or mechanisms described above.

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via a system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in certain embodiments of systems may be any type of known computer platform or a type to be developed in the future, such as a server, a main-frame computer, a work station or other computer type. When more than one platform is employed, they may be connected via any known or future type of cabling or other communication system including wireless systems, either networked or otherwise. They may be co-located, or they may be physically separated. Various operating systems may be employed on any of the computer platforms, possibly depending on the type and/or make of computer platform chosen. Appropriate operating systems include Windows NT^{ϵ}, Windows XP, Windows 7, Windows 8, iOS, Sun Solaris, Linux, OS/400, Compaq Tru64 Unix, SGI IRIX, Siemens Reliant Unix, iOS, Android, and others.

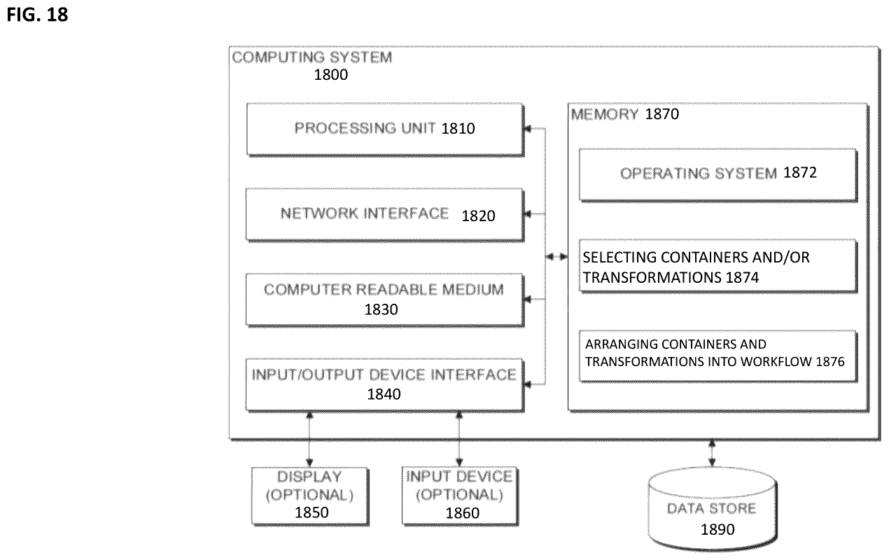

FIG. 18 depicts a general architecture of an example computing device 1800 according to certain embodiments. The general architecture of the computing device 1800 depicted in FIG. 18 includes an arrangement of computer hardware and software components. The computing device 1800 may include many more (or fewer) elements than those shown in FIG. 18. It is not necessary, however, that all of these generally conventional elements be shown in order to provide an enabling disclosure. As illustrated, the computing device 1800 includes a processing unit 1810, a network interface 1820, a computer readable medium 1830, an input/output device interface 1840, a display 1850, and an input device 1860, all of which may communicate with one another by way of a communication bus. The network interface 1820 may provide connectivity to one or more networks or computing systems. The processing unit 1810 may thus receive information and instructions from other computing systems or services via a network. The processing unit 1810 may also communicate to and from memory 1870 and further provide output information for an optional display 1850 via the input/output device interface 1840. The input/output device interface 1840 may also accept input from the optional input device 1860, such as a keyboard, mouse, digital pen, microphone, touch screen, gesture recognition system, voice recognition system, gamepad, accelerometer, gyroscope, or other input device.

The memory 1870 may contain computer program instructions (grouped as modules or components in some embodiments) that the processing unit 1810 executes in order to implement one or more embodiments. The memory 1870 generally includes RAM, ROM and/or other persistent, auxiliary or non-transitory computer-readable media. The memory 1870 may store an operating system 1872 that provides computer program instructions for use by the processing unit 1810 in the general administration and operation of the computing device 1800. The memory 1870 may further include computer program instructions and other information for implementing aspects of the present disclosure.

For example, in one embodiment, the memory 1870 includes a selecting containers and/or transformations module 1874 for selecting input data comprising standardized data containers, based on a first input from a user, and/or selecting transformations, based on user input, as well as arranging containers and transformations into workflow 1876 for arrange on a graphical interface graphical icons into a graphical workflow representing a data analysis, wherein the workflow comprises a plurality of standardized data transformations and standardized data containers comprising intermediate and final results of the data analysis, as described above.

### Computer-Readable Storage Mediums

Aspects of the present disclosure further include non-transitory computer readable storage mediums having instructions for practicing the subject methods. Computer readable storage mediums may be employed on one or more computers for complete automation or partial automation of a system for practicing methods described herein. In certain embodiments, instructions in accordance with the method described herein can be coded onto a computer-readable medium in the form of “programming,” where the term “computer readable medium” as used herein refers to any non-transitory storage medium that participates in providing instructions and data to a computer for execution and processing. Examples of suitable non-transitory storage media include a floppy disc, hard disc, optical disc, magneto-optical disc, CD-ROM, CD-R, magnetic tape, non-volatile memory card, ROM, DVD-ROM, Blue-ray disc, solid state disc, and network attached storage (NAS), whether or not such devices are internal or external to the computer. A file containing information can be “stored” on a computer readable medium, where “storing” means recording information such that it is accessible and retrievable at a later date by a computer. The computer-implemented method described herein can be executed using programming that can be written in one or more of any number of computer programming languages. Such languages include, for example, Java (Sun Microsystems, Inc., Santa Clara, CA), Visual Basic (Microsoft Corp., Redmond, WA), C++(AT&T Corp., Bedminster, NJ), Python, as well as any many others.

In some embodiments, computer readable storage mediums of interest include a computer program stored thereon, where the computer program when loaded on the computer includes instructions comprising: algorithm for selecting input data comprising standardized data containers, based on a first input from a user, and algorithm for arranging on a graphical interface graphical icons into a graphical workflow representing a data analysis, based on a second input from the user, wherein the workflow comprises a plurality of standardized data transformations and standardized data containers comprising intermediate and final results of the data analysis.

### Utility

The subject methods and systems find use in a variety of applications where it is desirable to represent data analysis, in a more reproducible, and in some cases, more standardized, manner than presently available. In certain cases, the methods and systems find use in a variety of different applications, e.g., in connection with analyzing empirical data in a manner that promotes reproducibility in arriving at scientific results or conclusions. In some cases, the methods and systems find use in practicing bioinformatics or utilizing bioinformatic processes. Embodiments of the methods, systems and non-transitory computer readable media described herein provide advantages, in part, because in some cases they enable utilizing standardized elements to represent a data analysis in the context of graphical workflows that are accessible even to users without computer programing abilities or similar technical knowledge and that are configured to facilitate collaboration, maintain data integrity, comprise searchable elements and promote enabling reproducible results in discovering and publishing scientific findings.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112(f) or 35 U.S.C. § 112(6) is not invoked.

1. A computer-implemented method of representing data analysis comprising: selecting input data comprising standardized data containers, based on a first input from a user; and
arranging on a graphical interface graphical icons into a graphical workflow representing a data analysis, based on a second input from the user,
wherein the workflow comprises a plurality of standardized data transformations and standardized data containers comprising intermediate and final results of the data analysis.

2. The method of claim 1, further comprising:
selecting one or more containers, based on input from the user;
arranging one or more graphical icons representing the one or more containers in the graphical workflow representing the data analysis.

3. The method of claim 1, wherein the containers are associated with one or more files.

4-6. (canceled)

7. The method of 6 claim 1, wherein the containers comprise standardized data.

8. (canceled)

9. The method of claim 1, wherein the containers comprise input for the workflow.

10. The method of claim 1, wherein the containers comprise output of the workflow.

11. The method of claim 1, wherein the containers comprise input for applying a transformation.

12. The method of claim 1, wherein the containers comprise output of applying a transformation.

13-14. (canceled)

15. The method of claim 1, wherein the containers comprise standardized metadata.

16. The method of claim 15, wherein the standardized metadata are container attributes.

17-19. (canceled)

20. The method of claim 1, further comprising:
creating new containers or transformations or attributes by importing one or more data set or analytical operation, based on input received from the user.

21. The method of claim 1, further comprising:
annotating a container.

22-25. (canceled)

26. The method of claim 21, wherein annotating a container comprises:
training a machine learning model to annotate a container using descriptions of existing containers and corresponding attributes of the existing containers as training data;
applying the machine learning model to a description of the data associated with the container; and
annotating the transformation based on results of applying the machine learning model.

27. The method of claim 21, wherein annotating a container comprises:
applying a machine learning model, trained to identify container attributes based on a description, to a description of the data associated with the container; and
annotating the container based on results of applying the machine learning model.

28-34. (canceled)

35. The method of claim 1, wherein the containers comprise data sets.

36-48. (canceled)

49. The method of claim 1, wherein the containers comprise a second attribute linking the data set to an associated publication.

50-58. (canceled)

59. The method of claim 1, further comprising:
selecting one or more transformations, based on input from the user;
arranging one or more graphical icons representing the one or more transformations in the graphical workflow representing the data analysis.

60. The method of claim 1, wherein the transformations comprise operations performed on at least one input data set resulting in at least one output data set.

61. The method of claim 1, wherein the transformations comprise operations performed on at least one input container resulting in at least one output container.

62-63. (canceled)

64. The method of claim 61, wherein operations performed on at least one input container resulting in at least one output container comprise computer-executable code configured to take as input one or more data containers and produce as output one or more data containers.

65-76. (canceled)

77. The method of claim 1, further comprising:
annotating a transformation.

78-81. (canceled)

82. The method of claim 77, wherein annotating a transformation comprises:
training a machine learning model to annotate a transformation using a description of an existing transformation and corresponding attributes of the existing transformation as training data;
applying a machine learning model to a description of the transformation; and
annotating the transformation based on results of applying the machine learning model.

83. The method of claim 77, wherein annotating a transformation comprises:
applying a machine learning model, trained to identify transformation attributes based on a description, to a description of the transformation; and
annotating the transformation based on results of applying the machine learning model.

84. The method of claim 1, further comprising:
performing data analysis based on the workflow.

85. The method of claim 84, wherein performing data analysis based on the workflow comprises:
applying one or more transformations present in the workflow to one or more input containers present in the workflow; and
generating output results contained in one or more output containers present in the workflow, based on results of applying one or more transformations.

86-89. (canceled)

90. The method of claim 1, wherein the workflow comprises a visual representation of data analysis.

91-135. (canceled)

136. The method of claim 1, further comprising:
using the workflow to reproduce a data analysis.

137-141. (canceled)

142. The method of claim 1, further comprising:
generating a checksum value for one or more containers, one or more transformations or the workflow.

143. The method of claim 142, further comprising:
verifying the integrity of the one or more containers, the one or more transformations, or the workflow by comparing the checksum value against a reference value.

144-145. (canceled)

146. The method of claim 1, further comprising:
utilizing a blockchain to verify integrity of the workflow.

147-474. (canceled)
